(19) United States
(12) Patent Application Publication
(10) Pub. No.: US 2022/0389844 A1
(43) Pub. Date: Dec. 8, 2022

(54) MULTI-STAGE POWER GENERATION USING BYPRODUCTS FOR ENHANCED GENERATION

(71) Applicant: BJ Energy Solutions, LLC, Houston, TX (US)

(72) Inventors: Warren Zemlak, Houston, TX (US); Diankui Fu, Houston, TX (US); Charlie Leykum, Houston, TX (US)

(73) Assignee: BJ Energy Solutions, LLC, Houston, TX (US)

(21) Appl. No.: 17/805,814

(22) Filed: Jun. 7, 2022

Related U.S. Application Data
(60) Provisional application No. 63/202,328, filed on Jun. 7, 2021.

(51) Int. Cl. F01K 23/10; F01K 13/02; F01K 7/16; F01K 25/06; E21B 41/00

(52) U.S. Cl. CPC F01K 23/10; F01K 13/02; F01K 7/16; F01K 25/06; E21B 41/0057; F05D 2220/76; F05D 2210/12; F05D 2220/60; F05D 2220/72

(57) ABSTRACT

A power generation assembly and related methods to enhance power efficiency and reduce greenhouse gas emissions associated with a power-dependent operation, may include a gas turbine engine. The power generation assembly also may include a heat exchanger positioned to receive exhaust gas from the gas turbine engine during operation. The heat exchanger may include an exhaust gas inlet positioned to receive exhaust gas and a liquid inlet positioned to receive liquid. The heat exchanger may be positioned to convert liquid into steam via heat from the exhaust gas. The power generation assembly further may include a steam turbine positioned to receive steam from the heat exchanger and convert energy from the steam into mechanical power. The power generation assembly still further may include an electric power generation device connected to the steam turbine and positioned to convert the mechanical power from the steam turbine into electrical power.

### CROSS-REFERENCE TO RELATED PATENT APPLICATIONS

This application claims the benefit of priority of U.S. Provisional Application No. 63/202,328 filed on Jun. 7, 2021, entitled “POWER GENERATION ASSEMBLIES TO ENHANCE POWER EFFICIENCY AND REDUCE GREENHOUSE GAS EMISSIONS, AND RELATED METHODS,” the contents of which is incorporated by reference.

### TECHNICAL FIELD

The present disclosure relates to power generation assemblies to enhance power efficiency and reduce greenhouse gas emissions, and related methods and, more particularly, to power generation assemblies to enhance power efficiency and reduce greenhouse gas emissions associated with power-dependent operations, and related methods.

### BACKGROUND

Some operations are driven by internal combustion engines to mechanically drive equipment or to drive electric generators to create electricity to drive equipment. The use of fossil fuels in the combustion engines may result in undesirable emissions into the environment, such as greenhouse gas emissions. In less efficient operations, more fuel is required, thus resulting in more undesirable emissions into the environment.

### SUMMARY

Generation of power may suffer from inefficiencies and/or undesirable greenhouse gas emissions into the environment. The present disclosure generally is directed to power generation assemblies to enhance power supply efficiency and/or reduce greenhouse gas emissions associated with the operations, and related methods.

Embodiments of this disclosure provide several techniques for improving the efficiency of power generation by addressing one or more of the above-referenced drawbacks, as well as other possible drawbacks. Benefits of the embodiments of this disclosure may be particularly beneficial for operations where it may be difficult or costly to supply materials for use at the location of the operation. An example operation in which the benefits may be applied is oilfield or wellsite operations, which may include well construction, completion, and/or production relying on the use of numerous components often having periods of operation and activity requiring large quantities of mechanical and/or electrical power created by an internal combustion engine. Efficiency may be improved by using a multiple-stage power generation system, in which the byproducts of one stage may be used to enhance operation of a later stage of the power generation system. For example, a second stage of power generation operated based on the byproduct of a first stage of power generation may improve efficiency of power generation by recovering some lost energy from the first stage and/or reducing emissions of the first stage. Each stage may be configured to generate electrical power (e.g., an electrical current that can be used to perform work such as rotating a motor), mechanical power (e.g., a rotational force that can be used to perform work such as rotating a motor), a combination of electrical and mechanical power, or perform some other work (e.g., cause a chemical reaction). Some embodiments may include more than two stages and different combinations of components to provide multiple stages of power generation with enhanced efficiency and/or reduced emissions.

According to embodiments of this disclosure, a power generation system may include a first turbine (e.g., a gas turbine engine or GTE, as described below) configured to generate a first mechanical power from a first source (e.g., fuel, fuel supply, or fuel supplies, as described below), a first generator (e.g., electric power generation device, as described below) coupled to the first turbine and coupled to a first load (e.g., power-dependent operation, power storage device, or mechanical device, as described below) and configured to generate a first electrical power from the first mechanical power and to transmit the first electrical power to the first load, a first conversion device (e.g., heat exchanger or distillation column or other manner of harvesting heat or energy from the first byproduct, as described below) coupled to the first turbine and configured to receive from the first turbine a first byproduct (e.g., exhaust gas, as described below), to receive a second source (e.g., liquid source, liquid, water, or water source, as described below), and to use the first byproduct to convert the second source to a third source (e.g., steam, as described below), a second turbine (e.g., steam turbine, as described below) coupled to the first conversion device and configured to generate a second mechanical power from the third source, and a second generator (e.g., electric power generation device, as described below) coupled to the second turbine and coupled to a second load (e.g., power-dependent operation, power storage device, or mechanical device, as described below) and configured to generate a second electrical power from the second mechanical power and to transmit the second electrical power to the second load.

In some embodiments, the first load may include at least one of an electric power grid, a solar farm, a wind farm, a wellsite operation, a mining site operation, a wastewater treatment operation, a natural gas production operation, a cryptocurrency operation, a power storage device, a chemical power storage device, a mechanical power storage device, a methane pyrolysis unit, or an electrolysis unit.

In some embodiments, the second load may include at least one of an electric power grid, a solar farm, a wind farm, a wellsite operation, a mining site operation, a wastewater treatment operation, a natural gas production operation, a cryptocurrency operation, a power storage device, a chemical power storage device, a mechanical power storage device, a methane pyrolysis unit, or an electrolysis unit.

In some embodiments, the second source may include at least one of a flowback water, a produced water, a geothermal water, or a wastewater.

In some embodiments, the second turbine may be part of a closed-loop organic Rankine cycle.

In some embodiments, the first load may include a first motor (e.g., an electric motor or actuator, as described below) coupled to a first mechanical device (e.g., hydraulic pump, pump, compressor. equipment, or electrically-powered equipment, as described below) and configured to mechanically drive the first mechanical device.

In some embodiments, the second load may include a first motor coupled to a first mechanical device and configured to mechanically drive the first mechanical device.

In some embodiments, the first load may include a first variable-frequency drive coupled to the first motor and configured to control the voltage to the first motor and may include a first transformer coupled to the first variable-frequency drive and configured to at least partially control the electrical power to the first variable-frequency drive.

In some embodiments, the power generation system may include a methanol generation assembly coupled to at least one of the first turbine or the first conversion device and coupled to at least one of the first generator or the second generator, and configured to receive at least one of the first electrical power or the second electrical power, to receive the first byproduct, to receive the second source, and to use the first byproduct and the second source to generate methane.

In some embodiments, the methanol generation assembly may include an electrolysis reactor coupled to at least one of the first generator or the second generator and configured to receive the second source, to receive at least one of the first electrical power or the second electrical power, and to generate oxygen and hydrogen from the second source.

In some embodiments, the methanol generation assembly may include a methanol generation reactor coupled to the electrolysis reactor, coupled to at least one of the first turbine or the first conversion device, and coupled to at least one of the first generator or the second generator, and configured to receive at least one of the first electrical power or the second electrical power, to receive the first byproduct, to receive hydrogen from the electrolysis reactor, and to use the first byproduct and the hydrogen to generate methane.

In some embodiments, the power generation system may include a condenser coupled to the first conversion device and coupled to a third load (e.g., power-dependent operation, mechanical device, as described below), wherein the condenser is configured to convert the third source to a fourth source (e.g., distilled liquid, as described below) and to transmit the fourth source to the third load.

In some embodiments, the power generation system may include one or more mobile chassis. In some embodiments, at least one of the first turbine, the first generator, the first conversion device, the second turbine, or the second generator may be coupled to the one or more mobile chassis.

In some embodiments, at least one of the first turbine or the first generator may be coupled to a first mobile chassis and at least one of the first conversion device, the second turbine, or the second generator may be coupled to a second mobile chassis.

In some embodiments, at least one of the first turbine or the first conversion device may be coupled to an injection well to transmit the first byproduct to the injection well, and the injection well may be configured to receive the first byproduct and to dispose of the first byproduct.

One embodiment may include supplying a first source to a first turbine, operating the first turbine to generate a first mechanical power from the first source, operating a first generator coupled to the first turbine and coupled to a first load to generate a first electrical power from the first mechanical power and to transmit the first electrical power to the first load, supplying a first byproduct from the operation of the first turbine to a first conversion device coupled to the first turbine and coupled to a second turbine, operating the first conversion device to use the first byproduct to convert a second source to a third source and to supply the third source to the second turbine, operating the second turbine to generate a second mechanical power from the third source, and operating a second generator coupled to the second turbine and coupled to a second load to generate a second electrical power from the second mechanical power and to transmit the second electrical power to the second load.

One embodiment may include connecting to one or more of a mobile chassis at least one of the first turbine, the first generator, the first conversion device, the second turbine, or the second generator.

One embodiment may include transporting at least one of the one or more mobile chassis to a location associated with at least one of the first load or the second load.

For example, in some embodiments, power generation at an operation site may include operating one or more gas turbine engines to supply one or more of mechanical power or electric power. In some embodiments, energy from exhaust gas generated during operation of the one or more gas turbine engines may be at least partially recovered and used to generate steam, which in some embodiments may be used to drive one or more steam turbines to produce additional electric power. The additional electric power may be used, for example, to supply additional power to equipment at an operation site and/or to generate additional electric power, which may be used to drive equipment, charge energy storage devices, and/or supply electric power to an electric power grid or other operations. In some embodiments, steam-generated power may be used to produce methanol, which may serve to as a fuel supplement for operation of the one or more gas turbine engines. This fuel supplement may further reduce greenhouse gas emissions, as well as reducing the overall fuel demand for the operation. Some embodiments may provide a mobile, modular, and/or scalable power generation operation for enhancing efficient power supply to a power-dependent operation while reducing greenhouse gas emissions.

According to some embodiments, a power generation assembly to one or more of enhance power efficiency or reduce greenhouse gas emissions may include a gas turbine engine positioned to convert fuel into mechanical power. The gas turbine engine may include a gas turbine output shaft and an exhaust gas duct positioned to receive exhaust gas during operation of the gas turbine engine. The power generation assembly also may include a speed reduction gear including a transmission input shaft connected to the gas turbine output shaft, a transmission output shaft, and a gear assembly positioned to cause the transmission output shaft to rotate at a different rotational speed than a rotational speed of the transmission input shaft. The power generation assembly further may include a first electric power generation device including a generator input shaft connected to the transmission output shaft and positioned to convert mechanical power supplied by the gas turbine engine into electrical power. The power generation assembly still further may include a heat exchanger, or other device configured to harness heat, positioned to receive the exhaust gas during operation of the gas turbine engine. The heat exchanger may include an exhaust gas inlet positioned to receive exhaust gas from the exhaust gas duct and a liquid inlet positioned to receive liquid from a liquid source. The heat exchanger may be positioned to convert liquid into steam via heat from the exhaust gas. The power generation assembly also may include a steam turbine positioned to receive steam from the heat exchanger and to convert energy from the steam into mechanical power. The power generation assembly still further may include a second electric power generation device connected to the steam turbine and positioned to convert the mechanical power from the steam turbine into electrical power. In some embodiments, one or more of the first electric power generation device or the second electric power generation device may be positioned to supply electric power to one or more of one or more power-dependent operations or one or more power storage devices.

According to some embodiments, a modular and scalable power generation operation may include a plurality of power generation assemblies according to at least some embodiments. Each of the plurality of power generation assemblies may be electrically connectable to supply electric power to one or more electrically-powered devices associated with one or more of one or more power-dependent operations or one or more power storage devices.

According to some embodiments, a method to one or more of enhance power efficiency or reduce greenhouse gas emissions may include operating a gas turbine engine to convert fuel into mechanical power, and supplying the mechanical power from the gas turbine engine to a speed reduction gear to change a rotational output speed of the mechanical power supplied by the gas turbine engine to a transmission rotational output speed. The method may further include supplying the mechanical power at the speed reduction gear rotational output speed to a first electric power generation device to convert the mechanical power from the gas turbine engine into electrical power. The method still further may include supplying exhaust gas from operation of the gas turbine engine and liquid to a heat exchanger to convert liquid into steam via heat from the exhaust gas, and supplying steam to a steam turbine positioned to convert energy from the steam into mechanical power. The method also may include supplying the mechanical power from the steam turbine to a second electric power generation device to convert the mechanical power from the steam turbine into electrical power. In some embodiments, the method further may include supplying electric power from one or more of the first electric power generation device or the second electric power generation device to one or more of one or more power-dependent operations or one or more power storage devices.

According to some embodiments, a method of supplying power to one or more of one or more power-dependent operations or one or more power storage devices may include moving a plurality of power generation assemblies to a geographic location associated with the one or more of the electric power grid, the solar farm, the wind farm, or the wellsite operation. The method further may include supplying power, according to at least some embodiments for supplying power, to the one or more of the one or more power-dependent operations or one or more power storage devices.

According to some embodiments, a power generation assembly to enhance power efficiency and/or reduce greenhouse gas emissions associated with a wellsite operation, may include a gas turbine engine positioned to convert fuel into mechanical power. The gas turbine engine may include an exhaust gas duct positioned to receive exhaust gas during operation of the gas turbine engine. The power generation assembly also may include a heat exchanger positioned to receive the exhaust gas during operation of the gas turbine engine. The heat exchanger may include an exhaust gas inlet positioned to receive exhaust gas from the exhaust gas duct and a liquid inlet positioned to receive liquid from a liquid source. The heat exchanger may be positioned to convert liquid into steam via heat from the exhaust gas. The power generation assembly further may include a steam turbine positioned to receive steam from the heat exchanger and to convert energy from the steam into mechanical power. The power generation assembly still further may include an electric power generation device connected to the steam turbine and positioned to convert the mechanical power from the steam turbine into electrical power.

In some embodiments, a power generation assembly to enhance power efficiency and/or reduce greenhouse gas emissions associated with a wellsite operation, may include a gas turbine engine positioned to convert fuel into mechanical power. The gas turbine engine may include an exhaust gas duct positioned to receive exhaust gas during operation of the gas turbine engine. The power generation assembly also may include a distillation column positioned to receive the exhaust gas during operation of the gas turbine engine. The distillation column may include an exhaust gas inlet positioned to receive exhaust gas from the exhaust gas duct, and a liquid inlet positioned to receive liquid from a liquid source. The distillation column may be positioned to convert liquid into steam via heat from the exhaust gas. The distillation column also may include a steam outlet positioned at an upper portion of the distillation column to release steam. The power generation assembly further may include a condenser positioned to receive fluid flow from the steam outlet and to condense steam to provide a distilled liquid for use in wellsite operations.

In some embodiments, a method to enhance power efficiency and/or reduce greenhouse gas emissions associated with a wellsite operation, may include operating a gas turbine engine to convert fuel into mechanical power, and supplying exhaust gas from operation of the gas turbine engine and liquid to a heat exchanger to convert liquid into steam via heat from the exhaust gas. The method also may include supplying steam to a steam turbine positioned to convert energy from the steam into mechanical power, and supplying the mechanical power from steam turbine to an electric power generation device to convert the mechanical power from the steam turbine into electrical power.

In some embodiments, a method to generate power and supply water to enhance a wellsite operation may include operating a gas turbine engine to convert fuel into mechanical power, and supplying exhaust gas from operation of the gas turbine engine to a distillation column. The method also may include supplying liquid to the distillation column, and heating the liquid in the distillation column via heat from the exhaust gas to generate steam. The method further may include supplying the steam to a condenser, and condensing the steam via the condenser to provide distilled liquid. The method still further may include supplying the distilled liquid to the wellsite operation.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to more clearly illustrate embodiments of the disclosure.

FIG. 1 is a schematic illustrating an example power generation operation including a plurality of example power generation systems according to some embodiments of the disclosure.

FIG. 2 is a diagrammatic representation of example power generation, use, conversion, recovery, and storage according to two example stages according to some embodiments of the disclosure.

FIG. 3 is a schematic side view of an example power generation assembly according to some embodiments of the disclosure.

FIG. 4 is a block diagram of an example power generation assembly for example power-dependent operations according to some embodiments of the disclosure.

FIG. 5 is a block diagram of an example power generation assembly for example power-dependent operations including an example methanol conversion assembly according to some embodiments of the disclosure.

FIG. 6 is a block diagram of an example power generation assembly for example power-dependent operations including an example distillation column supplied with heat from exhaust gas from a gas turbine engine according to some embodiments of the disclosure.

FIG. 7 is a block diagram of an example method to enhance power efficiency and/or reduce greenhouse gas emissions associated with a power-dependent operation according to some embodiments of the disclosure.

FIG. 8A is a block diagram of an example method to enhance power efficiency and/or reduce greenhouse gas emissions associated with example power-dependent operations according to some embodiments of the disclosure.

FIG. 8B is a continuation of the block diagram of FIG. 8A according to some embodiments of the disclosure.

FIG. 9A is a block diagram of an example method to generate power and supply distilled liquid to enhance a power-dependent operation according to some embodiments of the disclosure.

FIG. 9B is a continuation of the block diagram of FIG. 9A according to some embodiments of the disclosure.

FIG. 10 is a schematic illustrating an example operation including an example hydraulic fracturing system and an example power generation assembly according to some embodiments of the disclosure.

FIG. 11 is a diagrammatic representation of example power generation, use, conversion, recovery, and storage according to two example stages according to some embodiments of the disclosure.

FIG. 12 is a schematic side view of example wellsite equipment including an example hydraulic fracturing unit incorporated into an example power generation assembly according to some embodiments of the disclosure.

FIG. 13 is a schematic side view of example wellsite equipment including another example hydraulic fracturing unit incorporated into an example power generation assembly according to some embodiments of the disclosure.

FIG. 14 is a block diagram of an example power generation assembly for an example wellsite operation including an example mechanically-driven hydraulic fracturing unit and an example electrically-driven hydraulic fracturing unit according to some embodiments of the disclosure.

FIG. 15 is a block diagram of an example power generation assembly for an example wellsite operation including an example mechanically-driven hydraulic fracturing unit and example power storage according to some embodiments of the disclosure.

FIG. 16 is a block diagram of an example power generation assembly for an example wellsite operation including an example mechanically-driven hydraulic fracturing unit and example supply of electric power to an electric power grid according to some embodiments of the disclosure.

FIG. 17 is a block diagram of an example power generation assembly for an example wellsite operation including an example electrically-driven hydraulic fracturing unit having two electric power sources according to some embodiments of the disclosure.

FIG. 18 is a block diagram of an example power generation assembly for an example wellsite operation including an example electrically-driven hydraulic fracturing unit and example power storage according to some embodiments of the disclosure.

FIG. 19 is a block diagram of an example power generation assembly for an example wellsite operation including an example electrically-driven hydraulic fracturing unit and example supply of electric power to an electric power grid according to some embodiments of the disclosure.

FIG. 20 is a block diagram of an example power generation assembly for an example wellsite operation including an example mechanically-driven hydraulic fracturing unit and an example methanol conversion assembly according to some embodiments of the disclosure.

FIG. 21 is a block diagram of an example power generation assembly for an example wellsite operation including an example electrically-driven hydraulic fracturing unit and an example methanol conversion assembly according to some embodiments of the disclosure.

FIG. 22 is a block diagram of an example power generation assembly for an example wellsite operation including an example mechanically-driven hydraulic fracturing unit, an example electrically-driven hydraulic fracturing unit, and/or example power storage, combined with an example distillation column supplied with heat from exhaust gas from a gas turbine engine according to some embodiments of the disclosure.

FIG. 23A is a block diagram of an example method to enhance power efficiency and/or reduce greenhouse gas emissions associated with a wellsite operation according to some embodiments of the disclosure.

FIG. 23B is a continuation of the block diagram of FIG. 23A according to some embodiments of the disclosure.

FIG. 23C is a continuation of the block diagram of FIGS. 23A and 23B according to some embodiments of the disclosure.

FIG. 23D is a continuation of the block diagram of FIGS. 23A, 23B, and 23C according to some embodiments of the disclosure.

FIG. 24A is a block diagram of an example method to generate power and supply distilled liquid to enhance a wellsite operation according to some embodiments of the disclosure.

FIG. 24B is a continuation of the block diagram of FIG. 24A according to some embodiments of the disclosure.

FIG. 24C is a continuation of the block diagram of FIGS. 24A and 24B according to some embodiments of the disclosure.

FIG. 25 is a block diagram of an example method to enhance power efficiency and/or reduce greenhouse gas emissions according to some embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

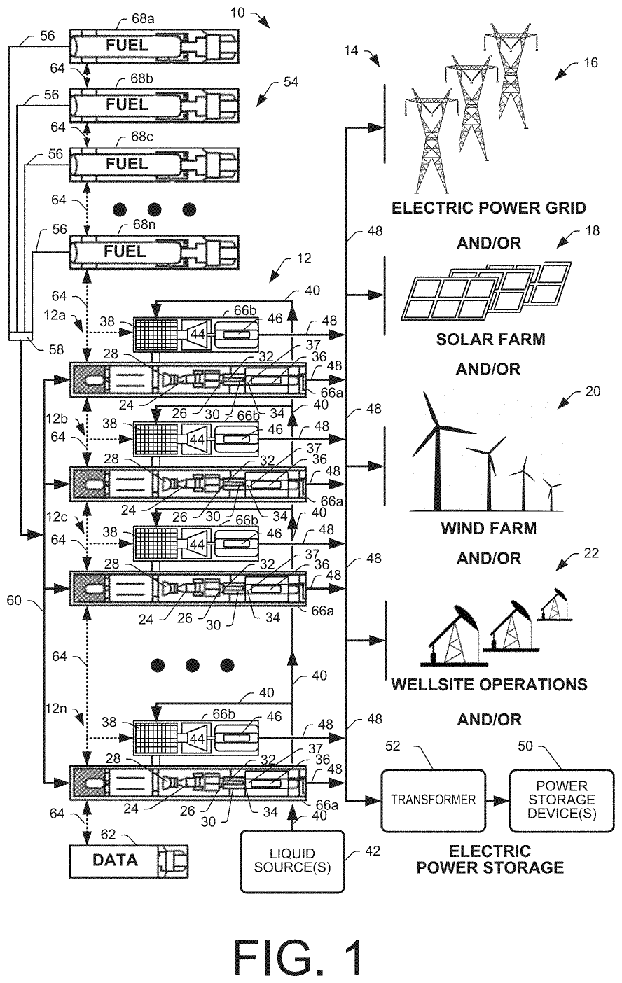

FIG. 1 schematically illustrates an example power generation operation 10 including a plurality of example power generation assemblies 12 according to some embodiments of the disclosure. The power generation operation 10 may provide a mobile, modular, and/or scalable power generation operation to supply power to one or more power-dependent operations 14, such as, for example, an electric power grid 16, a solar farm 18, a wind farm 20, or a wellsite operation 22 (e.g., an oil or gas wellsite, which may include well construction, completion, and/or production). Other power-dependent operations for use with power generation assemblies may include, for example, a mining site operation, a wastewater treatment operation, a natural gas production operation, or a cryptocurrency operation, as well as other types of power-dependent operations. Wastewater treatment may include any process or processes that receive wastewater and cause the wastewater to have a condition and/or composition rendering it relatively more useful for an intermediate or end purpose or function. Wastewater may include, but is not limited to, agricultural wastewater, industrial wastewater, sewage, etc. As shown in FIG. 1, in some embodiments, the power generation operation 10 may include a plurality of power generation assemblies 12, in which one or more of the power generation assemblies 12 may be electrically connectable to supply electric power to one or more electrically-powered devices associated with the one or more power-dependent operations 14.

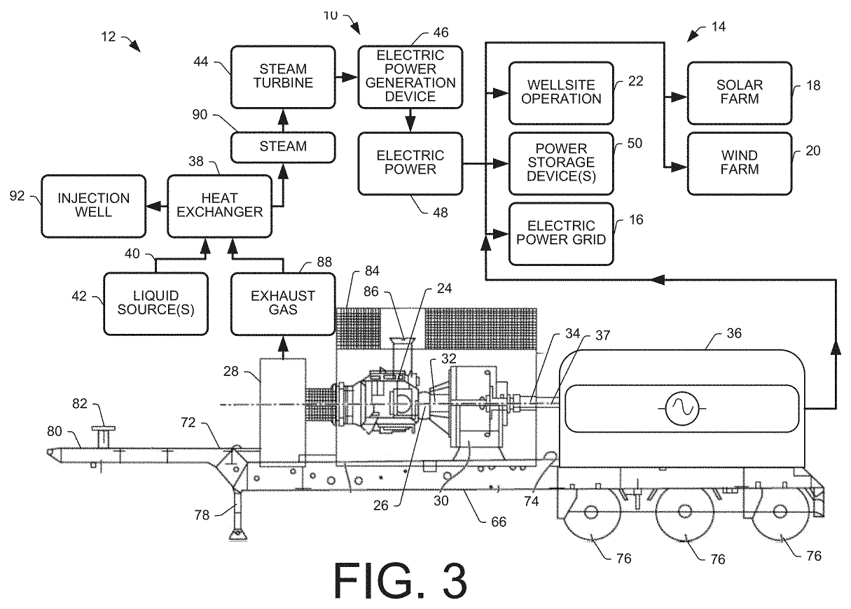

As shown in FIG. 1, in some embodiments, one or more of the power generation assemblies 12 may include a gas turbine engine (GTE) 24 positioned to convert fuel into mechanical power. The GTE 24 may include a gas turbine output shaft 26 and an exhaust gas duct 28 positioned to exhaust gas, such as combustion byproducts, during operation of the GTE 24. In some embodiments, the power generation assemblies 12 may include a speed reduction gear 30 including a transmission input shaft 32 connected to the gas turbine output shaft 26, a transmission output shaft 34, and a gear assembly positioned to cause the transmission output shaft 34 to rotate at a different rotational speed than a rotational speed of the transmission input shaft 32, for example, at a lower rotational speed than the transmission input shaft 32. The power generation assemblies 12, in some embodiments, further may include a first electric power generation device 36 including a generator input shaft 37 (such as in FIG. 3) connected to the transmission output shaft 34 and positioned to convert mechanical power supplied by the GTE 24 into electrical power.

In some embodiments, as shown in FIG. 1, the power generation assemblies 12 may also include a heat exchanger 38 positioned to receive the exhaust gas during operation of the GTE 24. The heat exchanger 38 may include an exhaust gas inlet positioned to receive exhaust gas from the exhaust gas duct 28. For example, the exhaust gas may be transported to the heat exchanger 38 via a conduit, or in some embodiments, the heat exchanger 38 may be incorporated into the exhaust gas duct 28 and may include an exhaust gas inlet to receive the exhaust gas as is passes through the exhaust gas duct 28. The heat exchanger 38 may also include a liquid inlet positioned to receive liquid 40 from a liquid source 42. The heat exchanger 38 may be configured to convert liquid 40 into steam via heat from the exhaust gas.

In some embodiments, the liquid source 42 may include, but is not limited to, flowback water, produced water, geothermal water, wastewater, and/or any other water or liquid readily available at the power-dependent operation 14. The produced water described herein may be or include any water originating from a subterranean formation or otherwise obtained from an oil or gas well. The produced water described herein may include any suitable concentrations of one or more of bromine, sodium chloride, barium, zinc, manganese, and iron. The wastewater described herein may be or include municipal wastewater (e.g., from a municipal water treatment facility).

In some embodiments, the liquid inlet of the heat exchanger 38 may be in fluid communication (directly or indirectly) with a liquid outlet located on and/or connected to one or more above-ground storage tanks (ASTs) located at or near a wellsite. The ASTs may contain produced water obtained from one or more wells located at or adjacent to the wellsite.

In some embodiments, the liquid inlet of the heat exchanger 38 may be in fluid communication (directly or indirectly) with a liquid outlet located on and/or connected to one or more storage tanks or vessels located at or near a municipal water treatment facility. Such storage tanks or vessels may contain wastewater, for example, municipal city wastewater.

The power generation assemblies 12 may further include a steam turbine 44 positioned to receive steam from the heat exchanger 38 and to convert energy from the steam into mechanical power. The steam received by steam turbine 44 may be generated by heat exchanger 38 from one or a combination of liquids, including wastewater (e.g., municipal city wastewater), water produced from a well (e.g., produced water from and oil or gas well), water captured from a river or stream, water captured from rain, or water produced by the power generation assembly 12. The steam turbine 44 may be mobile and disposed on one or more chassis, trailers, or modules. For example, the steam turbine 44 may be disposed on a single chassis or trailer. The power generation assemblies 12 further may include a second electric power generation device 46 connected to the steam turbine 44 and configured to convert the mechanical power from the steam turbine 44 into electrical power. In some embodiments, both the steam turbine 44 and the second electric power generation device 46 may be mobile and disposed on one or more chassis (which may be or include trailers or modules). For example, both the steam turbine 44 and the second electric power generation device 46 may be disposed on a single chassis.

In some embodiments, the steam turbine 44 may be replaced or augmented with a closed-loop organic Rankine cycle (ORC) system configured to receive heat energy and convert the heat energy into usable power. An organic Rankine cycle (ORC) is based on the use of an organic, high molecular mass fluid with a liquid-vapor phase change, or boiling point, occurring at a lower temperature than the water-steam phase change. The fluid allows Rankine cycle heat recovery from lower temperature sources such as biomass combustion, industrial waste heat, geothermal heat, heat from a vehicle exhaust stream and the like. The low-temperature heat is converted into useful work that may include conversion into electrical energy. The working principle of the organic Rankine cycle is the same as that of the Rankine cycle. That is, the working fluid is pumped to a boiler or heat exchanger where it is evaporated, passes through a turbine and is finally re-condensed. The expansion may be substantially adiabatic while the evaporation and condensation processes are substantially isobaric.

The ORC may receive the heat energy from the exhaust gas 88 during operation of the GTE 24. The ORC system may contain a heat exchanger for receiving the hot exhaust gas 88 in a hot side of the heat exchanger. An ORC fluid may pass into a cold side of the heat exchanger. The ORC fluid may any suitable organic phase liquid, such as diesel, kerosene, gasoline, or LNG, or the like. Heat from the exhaust gas 88 may pass to the ORC fluid in the heat exchanger to provide a heated ORC fluid having a gaseous or mixed phase state. The heated ORC fluid may then be introduced to a turbine whereby heat energy from the heated ORC fluid is transferred to mechanical energy and the heated ORC fluid is expanded into a vapor leaving the turbine. The vapor leaving the turbine may be compressed and condensed to provide the ORC fluid that is recycled to the cold side of the heat exchanger. The mechanical energy generated by the turbine can be transferred to an electrical generator to provide electrical energy. The ORC and/or the electrical generator may be mobile and disposed on one or more chassis, trailers, or modules. For example, the ORC and/or the electrical generator may be disposed on a single chassis or trailer. The ORC system may be beneficial when water supply is limited for steam generation by the heat exchanger 38.

One or more of the first electric power generation device 36 or the second electric power generation device 46 may be positioned to supply electric power 48 to one or more power-dependent operations 14, such as, for example, one or more of the electric power grid 16, the solar farm 18, the wind farm 20, the wellsite operation 22, or one or more power storage devices 50. In some embodiments, a transformer 52 may be provided in electrical communication with one or more of the first electric power generation device 36 or the second electric power generation device 46 and the one or more of the power storage devices 50, which may include one or more rechargeable batteries and/or one or more capacitors. The transformer 52 may be configured to transfer electrical power from the first electric power generation device 36 and/or the second electric power generation device 46 to the one or more power storage devices 50. Although the example power storage device(s) 50 shown in FIGS. 1 and 3-6 may be electric power storage device(s), other types of power storage devices are contemplated, such as, for example, chemical power storage devices (e.g., fuels and/or liquid/chemical power storage devices) and/or mechanical power storage devices (e.g., kinetic energy storage devices, flywheels, etc.).

In some embodiments, one or more of the GTEs 24 may be a dual-fuel or bi-fuel GTE, for example, capable of being operated using two or more different types of fuel, such as natural gas and diesel fuel, although other combinations of fuel may likewise be used. For example, a dual-fuel or bifuel GTE may be capable of being operated using a first type of fuel, a second type of fuel, and/or a combination of the first type of fuel and the second type of fuel. For example, the fuel may include gaseous fuels, such as, for example, compressed natural gas (CNG), natural gas, field gas, pipeline gas, methane, propane, butane, and/or liquid fuels, such as, for example, diesel fuel (e.g., #2 diesel), bio-diesel fuel, biofuel, alcohol, gasoline, gasohol, aviation fuel, and other fuels, as will be understood by those skilled in the art. Gaseous fuels may be supplied by CNG bulk vessels, a gas compressor, a liquid natural gas vaporizer, line gas, and/or well-gas produced natural gas. Other types and associated fuel supply sources are contemplated. The one or more GTEs 24 may be operated to provide horsepower to drive the speed reduction gear 30, which may be connected to one or more first electric power generation devices 36 to generate electric power, for example, for supplying power to one or more power-dependent operations 14.

The power generation operation 10 may include one or more fuel supplies 54 for supplying the GTEs 24 and any other fuel-powered components of the power generation operation 10, such as auxiliary equipment, with fuel. The fuel supplies 54 may include gaseous fuels, such as compressed natural gas (CNG), natural gas, field gas, pipeline gas, methane, propane, butane, and/or liquid fuels, such as, for example, diesel fuel (e.g., #2 diesel), bio-diesel fuel, biofuel, alcohol, gasoline, gasohol, aviation fuel, and other fuels as will be understood by those skilled in the art. Gaseous fuels may be supplied by CNG bulk vessels, such as fuel tanks coupled to trucks, a gas compressor, a liquid natural gas vaporizer, line gas, and/or well-gas produced natural gas. The fuel may be supplied to the power generation assemblies 12 by one of more fuel lines 56 supplying the fuel to a fuel manifold 58 and unit fuel lines 60 between the fuel manifold 58 and the power generation assemblies 12. Other types and associated fuel supply sources and arrangements are contemplated, as will be understood by those skilled in the art.

As shown in FIG. 1, some embodiments also may include one or more data centers 62 configured to facilitate receipt and transmission of data communications related to operation of one or more of the components of the power generation operation 10. Such data communications may be received and/or transmitted via one or more communications links 64, such as hard-wired communications cables and/or wireless communications, for example, according to known communications protocols. For example, the data centers 62 may contain at least some components of a power generation control assembly, such as a supervisory controller configured to receive signals from components of the power generation operation 10 and/or communicate control signals to components of the power generation operation 10, for example, to at least partially control operation of one or more components of the power generation assemblies 12, such as, for example, the GTEs 24, the speed reduction gears 30, the first electric power generation devices 36, the heat exchangers 38, the steam turbines 44, the second electric power generation devices 46, the transformers 52, the power storage device(s) 50, the fuel supplies 54, etc., and/or any associated valves, pumps, and/or other components of the power generation operation 10.

The power generation operation 10 may provide a mobile, modular, and/or scalable power generation operation to supply power to one or more power-dependent operations 14. For example, one or more of the power generation assemblies 12 may include a mobile chassis 66 (such as shown in FIG. 3), and one or more of the GTE 24, the speed reduction gear 30, the first electric power generation device 36, the heat exchanger 38, the steam turbine 44, or the second electric power generation device 46 may be connected to the mobile chassis 66. Some embodiments may include a first mobile chassis 66a, and one or more of the GTE 24, the speed reduction gear 30, or the first electric power generation device 36 may be connected to (e.g., supported and/or transportable on) the first mobile chassis 66a. Some embodiments may also include a second mobile chassis 66b, and one or more of the heat exchanger 38, the steam turbine 44, or the second power electric power generation device 46 may be connected to (e.g., supported and/or transportable on) the second mobile chassis 66b.

Some embodiments may include one or more of the first mobile chassis 66a. In some embodiments, the first mobile chassis 66a may be connected to one or more GTE 24. Some embodiments may include one or more of the second mobile chassis 66b. In some embodiments, the second mobile chassis 66b may be connected to one or more steam turbine 44. In some embodiments, the one or more GTE 24 connected to a first mobile chassis 66a and the one or more GTE 24 connected to another first mobile chassis 66a may together provide heat energy for one or more steam turbine 44. For example, the exhaust gases 88 provided by the GTE 24 located on a first mobile chassis 66a may be mixed with or otherwise combined with the exhaust gases 88 provided by the GTE 24 located on another first mobile chassis 66a to provide heat energy for a steam turbine 44, for example, a steam turbine 44 located on a second mobile chassis 66b. In other embodiments, 2, 4, 6, or 8 GTE 24 may provide heat energy for 1, 2, 3, or 4 or more steam turbines 44. In some embodiments, the ratio of the number of GTE 24 to the number of steam turbine 44 may be from 1:1 to 4:1, for example 2:1. In some embodiments, the steam turbine 44 is selected to have a power rating that is the same as or substantially the same as the power rating of the GTE 24. In some embodiments, the steam turbine 44 is selected to have a power rating that is the same as or substantially the same as the combined power rating of all of the GTEs 24 providing heat energy for the steam turbine 44. For example, a GTE 24 having an output power of about 4 MW located on a first mobile chassis 66a may provide heat energy that may be combined with the heat energy provided by a GTE 24 (also having an output power of about 4 MW) located on another first mobile chassis 66a to provide heat energy for a single steam turbine 44 having an output power rating of about 8 MW. Other combinations of components and mobile chassis are contemplated. The provision of mobile chassis 66 for the power generation assemblies 12 may facilitate transport of the power generation assemblies 12 to a remote site for set-up, operation, and take-down following the operation. Thereafter, the mobile chassis 66 may facilitate transport of the power generation assemblies 12 to another geographic location for set-up and operation.

The power generation operation 10 may be modular and/or scalable, for example, to tailor capabilities to a given power-dependent operation. For example, as shown in FIG. 1, the power generation operation 10 may include a first power generation assembly 12a, a second power generation assembly 12b, and a third power generation assembly 12c through an n^{th} power generation assembly 12n, for example, to provide a power generation capacity sufficient to meet the power requirements of a given power-dependent operation 14. As shown in FIG. 1, in some embodiments, the fuel supplies 54 may be provided by one or more fuel trucks 68a, 68b, and 68c through 68n, and/or via a pipeline, for example, to provide sufficient fuel to operate the power generation assemblies 12 to meet the power requirements of a given power-dependent operation 14.

Applicant has recognized that natural gas may be one of the cleanest-burning fossil fuels. As a result, in some embodiments, natural gas may be used to generate power by supplying natural gas to the one or more GTEs 24 as a fuel. For example, the GTEs 24 may be supplied with natural gas, and the GTEs 24 may convert chemical energy in the natural gas to mechanical energy through combustion. As outlined above, the mechanical energy may be used to drive the first electric power generation devices 36, which may convert the mechanical energy into electric energy. In some embodiments, the power generation operation 10 may be configured to use natural gas as fuel for combustion in one or more of the GTEs 24 to provide power to meet increasing power demands across many industries, for example, for generation of electric power to supply electric power for supplementing electric power grids, such as utility grids and micro-grids, for example, during peak power demands or during emergencies, such as during instances where a modular, scalable, mobile, temporary, and/or semi-permanent power supply may be beneficial or required.

In some embodiments, the power generation assemblies 12 may enhance power supply efficiency and/or reduce greenhouse gas emissions associated with power-dependent operations 14, such as, for example, those shown in FIG. 1 and/or described herein, including wellsite operations, which may include well construction, completion, and/or production. For example, in some embodiments, power generation at the power-dependent operation 14 may include operating one or more GTEs 24 to supply one or more of mechanical power or electric power. Energy from exhaust gas generated during operation of the one or more GTEs 24 may be at least partially recovered and used to generate steam, which in some embodiments, may be used to drive one or more steam turbines 44 to produce electric power. The electric power may be used, for example, to supply additional power to equipment and/or to generate additional electric power, which may be used to drive equipment, charge the one or more power storage devices 50, and/or to supply electric power to the electric power grid 16. In some embodiments, steam-generated power may be used to produce methanol, which may serve to as a fuel supplement for operation of the GI′Es 24 supplying power to the one or more first electric power generation devices 36. This may further reduce greenhouse gas emissions and/or may reduce the overall fuel demand of the power-dependent operation.

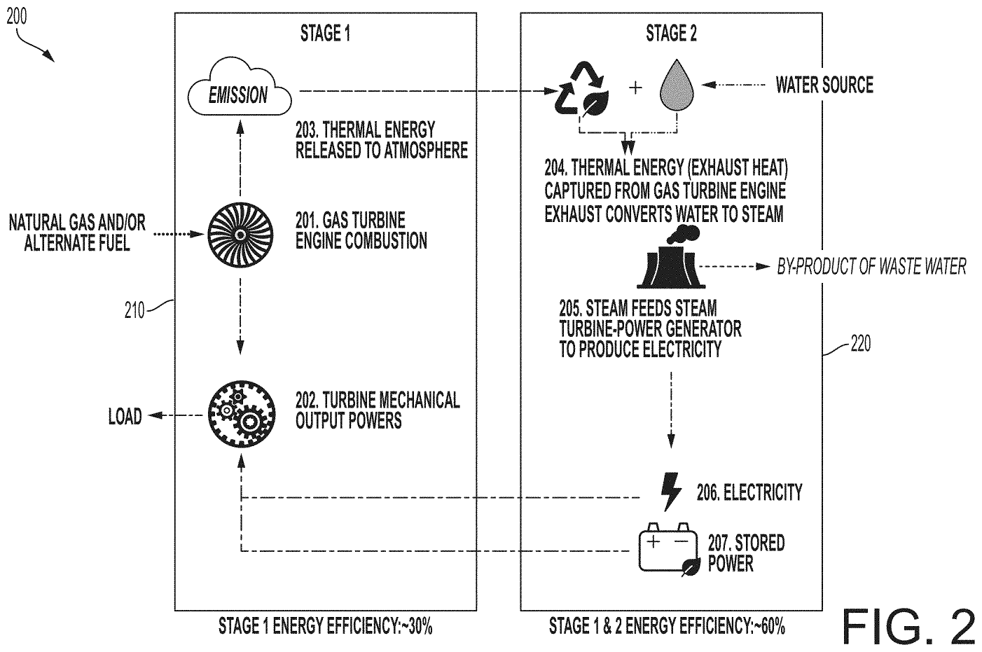

FIG. 2 is a diagrammatic representation of example power generation, use, conversion, recovery, and storage with two example stages according to some embodiments of the disclosure. First stage 210 of the example power-dependent operation 200, includes, at 201, supplying natural gas and/or an alternative fuel to a gas turbine engine. The alternative fuels may include liquid fuels, such as diesel, kerosene, mixed gas (e.g., hydrogen/natural gas), and/or other fuels described herein. At 202, the gas turbine engine, to meet an electricity demand and/or a mechanical-drive demand, supplies a power output to power a first electric power generation device, which may include an electric generator, and/or a mechanically driven machine. At 203, thermal energy in the form of exhaust gas resulting from operation of the gas turbine engine is released to the atmosphere. As noted herein, the exhaust gas may include undesirable greenhouse gas emissions to the environment, such as, for example, carbon dioxide, particulates, and other undesirable oxides, depending at least in part on the fuel supplied to the gas turbine engine and/or any after-treatment following combustion. As noted in FIG. 2, a typical expected energy efficiency for operations first stage 210 might be expected to be about 30%.

A second stage 220 of the example power-dependent operation 200, at 2044, may capture and use thermal energy from the exhaust gas from operation of the gas turbine engine to convert water to steam, instead of all the thermal energy in the exhaust gas being released to the atmosphere as at 203. For example, as shown, water from one or more of various water sources may be heated using the thermal energy to convert the water to steam. The water may be provided by wastewater and/or flowback water, which may be present at the location of the power-dependent operation. At 205, a steam turbine may be used to generate electricity using the steam from 204 and/or other steam sources. For example, the steam turbine may be connected to a second electric power generation device, which may include an electric generator, to supply mechanical power to the second electric power generation device to convert mechanical power into electric power at 6. The electric power may be used to meet electric power demands associated with the power-dependent operation, for example, to drive electrically-powered equipment. At 207, the electric power may be optionally stored, for example, in one or more electric power storage devices, such as, for example, rechargeable batteries and/or capacitors. Excess power may be supplied back to the system, such as to electric power for operating a fleet, an electric power grid, a chemical process such as hydrogen generation, etc. As noted in FIG. 2, a typical expected energy efficiency for operations 201-207 of combined stages 210 and 220 might be expected to be about 60%, or about double the expected energy efficiency for first stage 210 alone.

FIG. 3 is a schematic side view of an example power generation assembly 12 according to some embodiments of the disclosure. Assembly 12 may include a speed reduction gear 30 having a transmission input shaft 32 connected to a gas turbine output shaft 26, such that the transmission input shaft 32 rotates at the same rotational speed as the gas turbine output shaft 26. The speed reduction gear 30 may also include a transmission output shaft 34 positioned to be driven by the transmission input shaft 32 at a different rotational speed than the transmission input shaft 32, for example, so that the operational speed of the GTE 24 and/or the operational speed of the first electric power generation device 36 are close to their respective optimized operational speed ranges. In some embodiments, the speed reduction gear 30 may be a reduction transmission including a reduction gear assembly, which results in the transmission output shaft 34 having a relatively slower rotational speed than the transmission input shaft 32. The speed reduction gear 30 may include a continuously-variable transmission, an automatic transmission including one or more planetary gear trains, a transmission shiftable between different ratios of input-to-output, etc., or any other suitable of types of speed reduction gears or transmissions.

The first electric power generation device 36 may include or be an electric generator. In some embodiments, the first electric power generation device 36 may include a generator input shaft 37 connected to the transmission output shaft 34, such that the transmission output shaft 34 drives the generator input shaft 37 at a desired rotational speed. For example, the transmission output shaft 34 may include an output shaft connection flange, and the generator input shaft 37 may include a drive shaft connection flange, and the output shaft connection flange and the drive shaft connection flange may be coupled to one another, for example, directly connected to one another. In some embodiments, the transmission output shaft 34 and the generator input shaft 37 may be connected to one another via a coupling, such as a universal joint and/or a torsional coupling.

The mobile chassis 66 may be, or include, a trailer 72 including a platform 74 for supporting components of the power generation assembly 12, one or more pairs of wheels 76 facilitating movement of the trailer 72, a pair of retractable supports 78 to support the power generation assembly 12 during use, and a tongue 80 including a coupler 82 for connecting the trailer 72 to a truck for transport of the power generation assembly 12 between operation sites to be incorporated into a power generation operation.

The power generation assembly 12 may include an enclosure 84 connected to and supported by the mobile chassis 66. In some embodiments, as shown in FIG. 3, the GTE 24 may be connected to the speed reduction gear 30 via the gas turbine output shaft 26 and the transmission input shaft 32, both of which may be substantially contained within the enclosure 84. The GTE 24 may include an air intake duct 86 and an exhaust gas duct 28 passing through walls of the enclosure 84 and connected to the GTE 24. The GTE 24 may be connected to the first electric power generation device 36 via the speed reduction gear 30, with the transmission output shaft 34 connected to the generator input shaft 37, for example, as explained herein.

In the embodiment shown in FIG. 3, the GTE 24 is positioned to convert fuel into mechanical power. The exhaust gas duct 28 of the GTE 24 is positioned to receive exhaust gas 88 during operation of the GTE 24. The example power generation assembly 12 shown also includes a heat exchanger 38 positioned to receive the exhaust gas 88 during operation of the GTE 24. The heat exchanger 38 may include an exhaust gas inlet positioned to receive the exhaust gas 88 from the exhaust gas duct 28, for example, as described herein, and a liquid inlet positioned to receive liquid from one or more liquid source(s) 42. The heat exchanger 38 may be configured to convert the liquid into steam 90 via heat from the exhaust gas 88. As shown, the power generation assembly 12, in some embodiments, may include a steam turbine 44 positioned to receive steam 90 from the heat exchanger 38 and to convert energy from the steam 90 into mechanical power. In some embodiments, a second electric power generation device 46 (e.g., an electric generator) may be connected to the steam turbine 44 and configured to convert the mechanical power from the steam turbine 44 into electric power 48.

As shown in FIG. 3, in some embodiments, at least a portion of the mechanical power supplied by the GTE 24 may be used to supply power to (or supplement power of) operate mechanical equipment associated with one or more power-dependent operations 14, such as, for example, an electric power grid 16 (e.g., a utility grid and/or a micro-grid), a solar farm 18, a wind farm 20, or a wellsite operation 22. The electric power generated by the first electric power generation device 36 and/or the second electric power generation device 46 may be used to supply electric power for operation of equipment (e.g., electrically-powered equipment) at a power-dependent site, such as to supply electric power for storage in one or more power storage devices 50, such as, for example, rechargeable batteries and/or capacitors, and/or to supply an electric power grid 16. As shown in FIG. 3, in some embodiments, at least a portion of the exhaust gas 88 (e.g., exhaust gas not used for generating steam) may be supplied to an injection well 92 for disposal. In some embodiments, exhaust gas 88 downstream relative to the heat exchanger 38 may be supplied to the injection well 92.

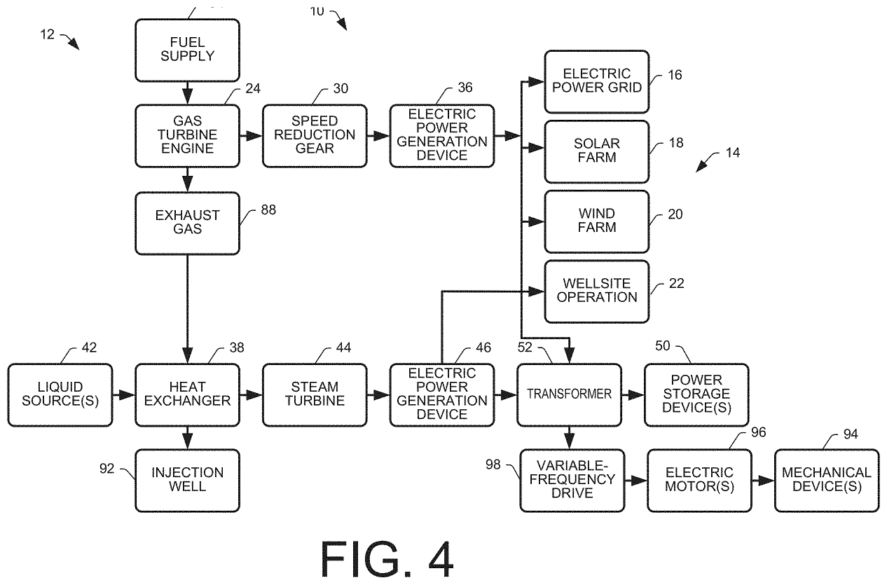

FIG. 4 is a block diagram of an example power generation assembly 12 for supplying power to a power-dependent operation 14, such as an electric power grid 16, a solar farm 18, a wind farm 20, a wellsite operation 22 according to some embodiments of the disclosure. The power generation assembly 12 also may be configured to supply power to one or more power storage devices 50 and/or to one or more mechanical devices 94, which may be powered by one or more electrically-powered actuators, such as one or more electric motors 96.

As shown in FIG. 4, a variable-frequency drive 98 in electrical communication with the one or more electric motors 96 and one or more of the first electric power generation device 36 or the second electric power generation device 46 may be provided. The variable-frequency drive 98 may be configured to control voltage supplied to the one or more electric motors 96. Some embodiments may include a transformer 52 in electrical communication with the variable-frequency drive 98 and one or more of the first electric power generation device 36 or the second electric power generation device 46. The transformer 52 may be configured to at least partially control electrical power supplied to the variable-frequency drive 98.

In some embodiments consistent with FIG. 4, one or more GTEs 24 may be used to supply mechanical power to respective electric power generation devices, which may generate electricity to combine with electricity generated by respective steam turbines 44, which generate power via steam (see, e.g., steam 90 in FIG. 3) generated via heat from the exhaust gas 88 generated by the GTEs 24 during operation. The combined electric power may be used to power various equipment (e.g., electrically-powered equipment), such as pumps and/or compressors, via electric motors, and/or other electrically-powered actuators. In some embodiments, liquid source(s) 42 (e.g., water sources) for steam generation may include any of the water sources described herein, including but not limited to, flowback water, produced water, geothermal water, wastewater, and/or any other water or liquid readily available at the power-dependent operation 14. In some embodiments, exhaust gas 88, after (or before) being used for heat for the heat exchanger 38, may be injected into an injection well 92, for example, to at least partially reduce the greenhouse gas emissions toward zero.

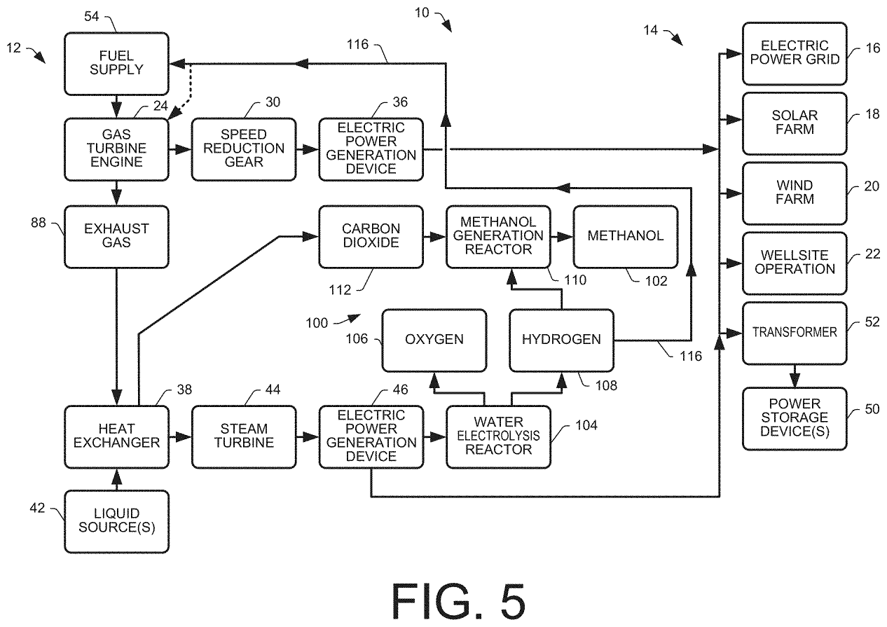

FIG. 5 is a block diagram of an example power generation assembly 12 for an example power-dependent operation 14, including an example methanol conversion assembly 100, according to embodiments of the disclosure. In the embodiment shown in FIG. 5, the power generation assembly 12 includes a methanol conversion assembly 100 configured to receive exhaust gas 88 via the exhaust gas duct 28 (see, e.g., FIG. 3) of the GTE 24, electrical power from one or more of the first electric power generation device 36 or the second power generation device 46, and liquid 40 from the one or more liquid source(s) 42. The methanol conversion assembly 100 may be configured to convert at least a portion of the exhaust gas 88 and a portion of the electrical power into methanol 102. In some embodiments, the methanol conversion assembly 100 may include a water electrolysis reactor 104 configured to split water into oxygen 106 and hydrogen 108. The methanol conversion assembly 100 also may include a methanol generation reactor 110 configured to cause carbon dioxide 112 in the at least a portion of the exhaust gas 88 to react with the hydrogen 108 to form methanol 114. Some embodiments may further include a conduit 116 providing fluid flow between the methanol conversion assembly 100 and a fuel supply 54 used to supply the GTE 24 or the GTE 24 (directly) to be used as fuel. In some embodiments, the fuel supply 54 may include one or more of natural gas, diesel fuel, gasoline, or other combustible fuel source. In some embodiments, at least a portion of one or more of the oxygen 106, the hydrogen 108, and/or the methanol 102 may be supplied to the fuel supply 54 and/or the GTE 24 to be used as fuel or as a supplement to fuel. For example, as shown in FIG. 5, at least a portion of the hydrogen 108 may be supplied to the fuel supply 54 and/or the GTE 24 via the conduit 116. Some embodiments may include a conduit providing fluid flow between the methanol conversion assembly 100 and one or more of the fuel supply to supply one or more internal combustion engines (e.g., other than the GTE 24) for at least a portion of the hydrogen 108 and/or the methanol 114 to be used as fuel. In some embodiments, the internal combustion engine may be used to supply power for the operation of auxiliary devices associated with the power-dependent operation(s) 14. In some embodiments, hydrogen may be obtained from at least a portion of the methanol 102, for example, via a methanol cracking process, and at least a portion of the hydrogen obtained from the methanol may be supplied to the GTE 24 as fuel and/or as a fuel supplement, for example, to be combined with natural gas and used as fuel for the GTE 24.

In some embodiments consistent with FIG. 5, one or more of the GTEs 24 may be used to mechanically drive respective electric power generation devices and/or other mechanically-driven devices. Heat from the exhaust gas 88 may be recovered via the heat exchanger(s) 38 to provide steam to drive the steam turbines 44 to generate electric power. The generated electric power may be used to split water into hydrogen and oxygen, for example, via electrolysis (e.g., using the water electrolysis reactor 104). The hydrogen may be reacted with carbon dioxide from the exhaust gas to produce liquid methanol, which may serve as a chemical energy storage medium, which may result in reducing greenhouse gas emission toward essentially zero. Alternatively, or in addition, the hydrogen may be blended with natural gas as a fuel source for the GTEs 24. In some embodiments, the liquid source(s) 42 (e.g., water sources) for steam generation may include, but are not limited to, flowback water, produced water, geothermal water, wastewater, and/or any other water of liquid readily available at the power generation operation 10.

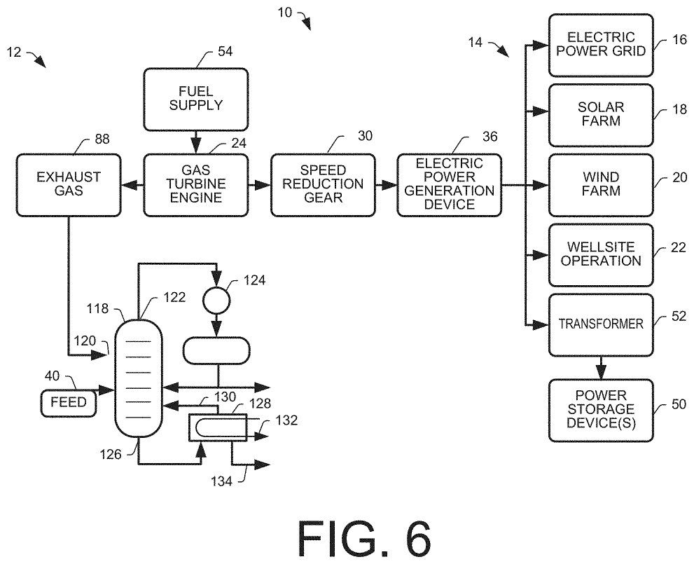

FIG. 6 is a block diagram of an example power generation assembly 12 for an example power-dependent operation 14, including an example distillation column 118 supplied with heat from the exhaust gas 88 of the GTE 24 according to some embodiments of the disclosure. The power generation assembly 12 may include a distillation column 118 positioned to receive the exhaust gas 88 during operation of the GTE 24. The distillation column 118 may include an exhaust gas inlet 120 positioned to receive exhaust gas 88 from the exhaust gas duct 28 (see, e.g., FIG. 3). The distillation column 118 may also include a liquid inlet positioned to receive liquid 40 from one or more liquid source(s) 42. The distillation column 118 may be positioned to convert liquid into steam via heat from the exhaust gas 88. The distillation column 118 also may include a steam outlet 122 positioned at an upper portion of the distillation column 118 to release steam. As shown in FIG. 6, the power generation assembly 12 may also include a condenser 124 positioned to receive fluid flow from the steam outlet 122 and to condense steam to provide a distilled liquid for use in power-dependent operations, such as, for example, an electric power grid 16, a solar farm 18, a wind farm 20, and/or a wellsite operation 22. The distilled liquid may be water. In some embodiments, at least a portion of the distilled liquid may be injected into the distillation column 118.

In some embodiments consistent with FIG. 6, the distillation column 118 may be a multitray distillation column including an outer shell. The distillation column 118 may include a feed stream inlet connected to and in fluid communication with the exhaust outlet to receive a heated exhaust gas 88 therefrom, a water inlet connected to and positioned proximate a bottom portion of the outer shell to receive a process water from the wellsite, and one or more distillate side streams connected to and positioned proximate a top portion of the outer shell to remove steam therefrom. The distillation column 118 may be arranged to transfer heat from the heated exhaust gas 88 to the process liquid (e.g., water) to thereby generate the steam.

In some embodiments, a bottoms stream 126 may be connected to and positioned proximate the bottom portion of the outer shell to receive a bottoms liquid product. In some embodiments, a reboiler 128 may be connected to and in fluid communication with the bottoms stream 126. For example, the reboiler 128 may be positioned to vaporize at least a portion of the bottoms liquid product in the bottoms stream 126 to produce a vapor 130 that may be reinjected onto a lower tray of the distillation column 118. A reboiler recovery stream 132 may be connected to and in fluid communication with the reboiler 128, and the reboiler recovery stream 132 may be positioned to receive a non-vaporized portion 134 of the bottoms liquid product to be used for other power-dependent operations, such as, for example, wellsite operations 22. For example, the non-vaporized portion 134 of the bottoms liquid product may be used as heavy brine for hydraulic fracturing operations.

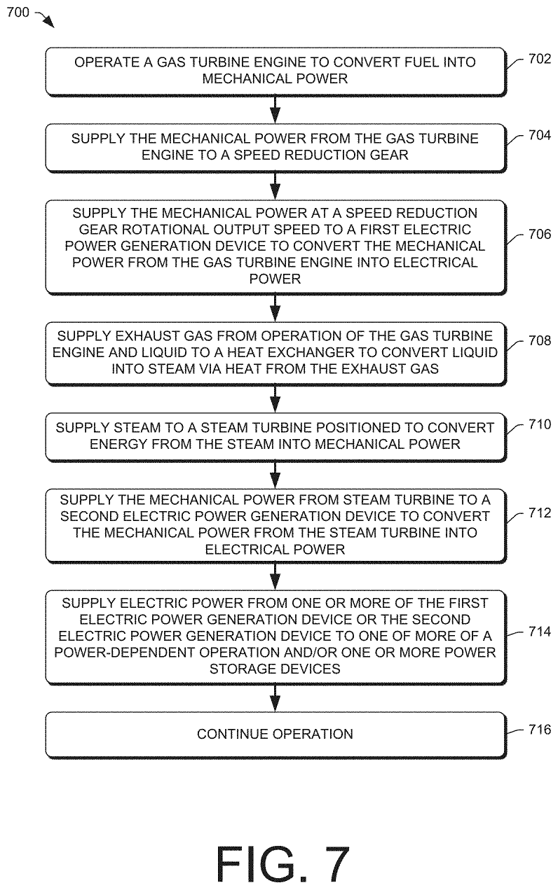

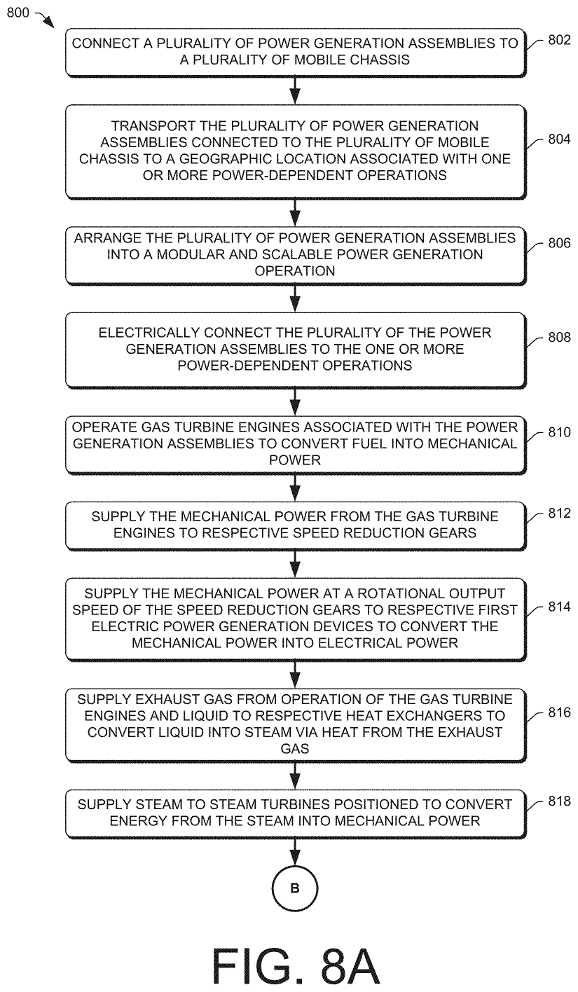

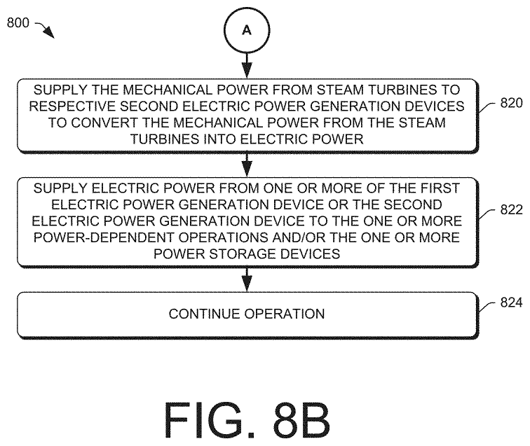

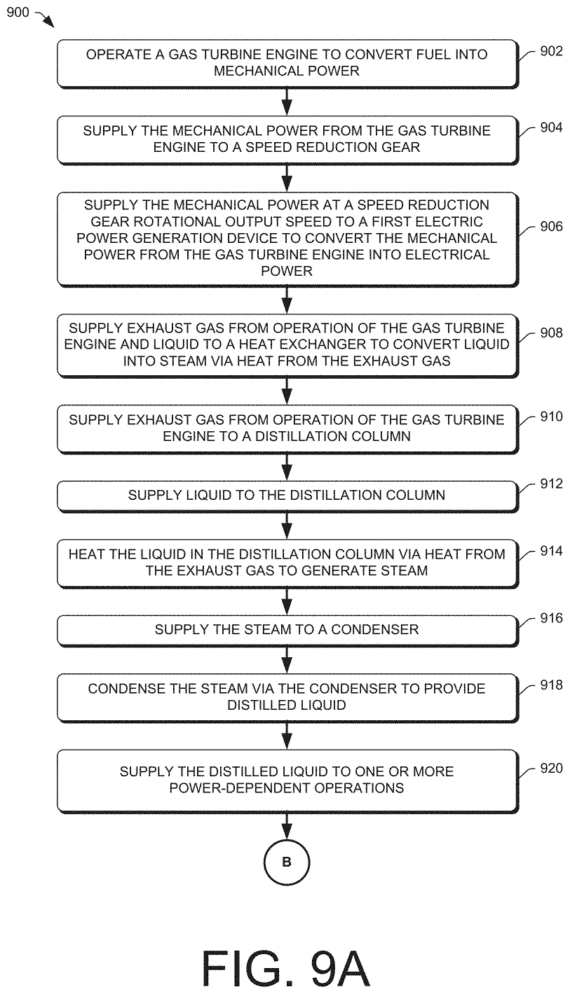

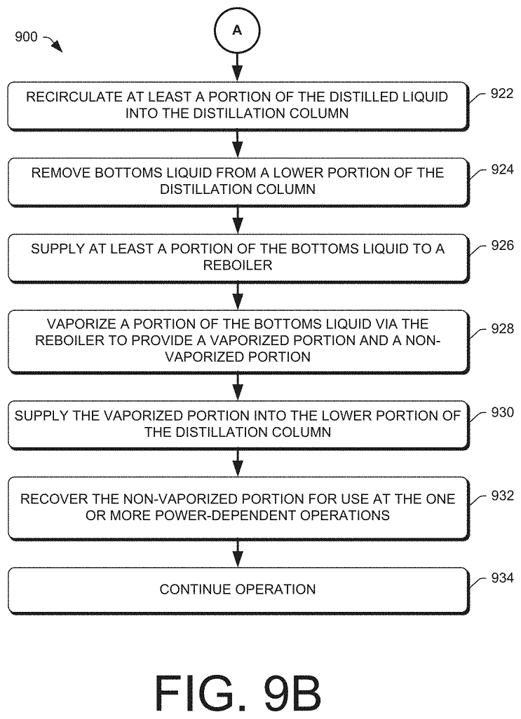

FIG. 7, FIG. 8A, FIG. 8B, FIG. 9A, and FIG. 9B show block diagrams of example methods 700, 800, and 900, respectively, according to embodiments of the disclosure, illustrated as respective collections of blocks in logical flow graphs, which represent a sequence of operations. FIG. 7 is a block diagram of an example method 700 to enhance power efficiency and/or reduce greenhouse gas emissions, according to embodiments of the disclosure. FIGS. 8A and 8B are a block diagram of an example method 800 to supply power to one or more power-dependent operations, according to embodiments of the disclosure. The power-dependent operations may include, for example, an electric power grid, a solar farm, a wind farm, a wellsite operation (e.g., an oil or gas wellsite, which may include well construction, completion, and/or production), a mining site operation, a wastewater treatment operation, a natural gas production operation, or a cryptocurrency operation, as well as other types of power-dependent operations. FIGS. 9A and 9B are a block diagram of an example method 900 to supply distilled liquid to one or more power-dependent operations, according to embodiments of the disclosure. For each of the respective example methods, the order in which the operations are described is not intended to be construed as a limitation, and any number of the described blocks may be combined in any order and/or in parallel to implement the method.

FIG. 7 is a block diagram of an example method 700 to enhance power efficiency and/or reduce greenhouse gas emissions according to some embodiments of the disclosure. An example method 700 includes, at 702, operating a gas turbine engine to convert fuel into mechanical power.

At 704, the example method 700 may include supplying the mechanical power from the gas turbine engine to a speed reduction gear.

The example method 700, at 706, may include supplying the mechanical power at a speed reduction gear rotational output speed to a first electric power generation device to convert the mechanical power from the gas turbine engine into electrical power.

At 708, the example method 700 may include supplying exhaust gas from operation of the gas turbine engine and liquid to a heat exchanger to convert liquid into steam via heat from the exhaust gas.

The example method 700, at 710, may include supplying steam to a steam turbine positioned to convert energy from the steam into mechanical power.

At 712, the example method 700 may include supplying the mechanical power from steam turbine to a second electric power generation device to convert the mechanical power from the steam turbine into electrical power.

The example method 700, at 714, may include supplying electric power from one or more of the first electric power generation device or the second electric power generation device to one or more power-dependent operations and/or one or more power storage devices (e.g., an electric power storage device).

At 716, the example method 700 may include continuing operation, for example, by continuing to supply electric power to the one or more power-dependent operations and/or one or more power storage devices, for example, as described in 702-714 and herein.

FIGS. 8A and 8B are a block diagram of an example method 800 to supply power to one or more power-dependent operations and/or one or more power storage devices according to some embodiments of the disclosure. An example method 800, at 802, may include connecting a plurality of power generation assemblies to a plurality of mobile chassis.

At 804, the example method 800 may include transporting the plurality of power generation assemblies connected to the plurality of mobile chassis to a geographic location associated with one or more of the power-dependent operations and/or the one or more power storage devices.

The example method 800, at 806 may include arranging the plurality of power generation assemblies into a modular and scalable power generation operation.

At 808, the example method 800 may include electrically connecting the plurality of the power generation assemblies to the one or more power-dependent operations and/or the one or more power storage devices.

The example method 800, at 810, may include operating gas turbine engines associated with the power generation assemblies to convert fuel into mechanical power.

At 812, the example method 800 may include supplying the mechanical power from the gas turbine engines to respective speed reduction gears.

The example method 800, at 814, may include supplying the mechanical power at a rotational output speed of the speed reduction gears to respective first electric power generation devices to convert the mechanical power into electrical power.

At 816, the example method 800 may include supplying exhaust gas from operation of the gas turbine engines and liquid to respective heat exchangers to convert liquid into steam via heat from the exhaust gas.

The example method 800, at 818, may include supplying steam to steam turbines positioned to convert energy from the steam into mechanical power.

At 820 (FIG. 8B), the example method 800 may include supplying the mechanical power from steam turbines to respective second electric power generation devices to convert the mechanical power from the steam turbines into electric power.

The example method 800, at 822, may include supplying electric power from one or more of the first electric power generation device or the second electric power generation device to the one or more power-dependent operations and/or the one or more power storage devices.

At 824, the example method 800 may include continuing operation, for example, by continuing to supply electric power to the one of more power-dependent operations and/or the one or more power storage devices, for example, as described in 810-822 and herein. In some embodiments, the example method 800 may further include, once the operation is complete, at least partially separating and/or disassembling the power generation assemblies and transporting at least some of them to another geographic location to supply power to another power-dependent operation.

FIGS. 9A and 9B are a block diagram of an example method 900 to supply distilled liquid to one or more power-dependent operations, according to embodiments of the disclosure. Example method 900 includes, at 902, operating a gas turbine engine (GTE) to convert fuel into mechanical power.

At 904, the example method 900 may include supplying the mechanical power from the gas turbine engine to a speed reduction gear.

The example method 900, at 906, may include supplying the mechanical power at a speed reduction gear rotational output speed to a first electric power generation device to convert the mechanical power from the gas turbine engine into electrical power.

At 908, the example method 900 may include supplying exhaust gas from operation of the gas turbine engine and liquid to a heat exchanger to convert liquid into steam via heat from the exhaust gas.

The example method 900, at 910, may include supplying exhaust gas from operation of the gas turbine engine to a distillation column.

At 912, the example method 900 may include supplying liquid to the distillation column.

The example method 900, at 914, may include heating the liquid in the distillation column via heat from the exhaust gas to generate steam.

At 916, the example method 900 may include supply the steam to a condenser.

The example method 900, at 918, may include condensing the steam via the condenser to provide distilled liquid.

At 920, the example method 900 may include supplying the distilled liquid to the one or more power-dependent operations.

The example method 900, at 922 (FIG. 9B), may include recirculating at least a portion of the distilled liquid into the distillation column.

At 924, the example method 900 may include removing bottoms liquid from a lower portion of the distillation column.

The example method 900, at 926, may include supplying at least a portion of the bottoms liquid to a reboiler.

At 928, the example method 900 may include vaporizing a portion of the bottoms liquid via the reboiler to provide a vaporized portion and a non-vaporized portion.

The example method 900, at 930, may include supplying the vaporized portion into the lower portion of the distillation column.

At 932, the example method 900 may include recovering the non-vaporized portion for use at the one or more power-dependent operations, for example, as described herein.

The example method 900, at 934, may include continuing operation, for example, by continuing to supply distilled water to the one of more power-dependent operations, for example, as described in 902-932 and herein.

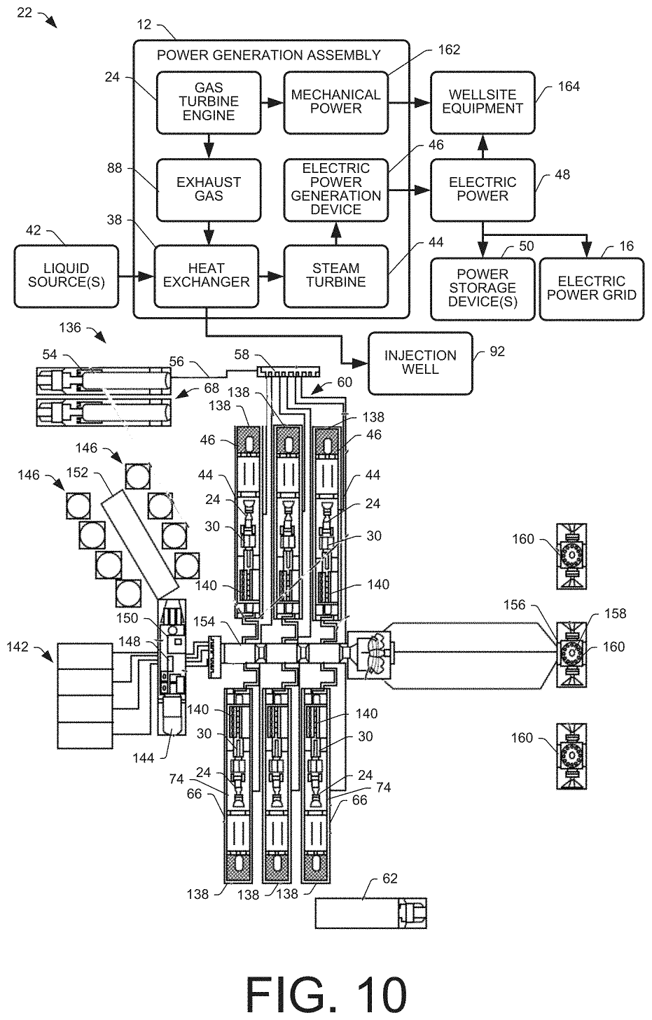

FIG. 10 schematically illustrates a top view of an example power-dependent operation 14 including an example wellsite operation 22, which includes an example hydraulic fracturing system 136. The wellsite operation 22 may be supplied with power by an example power generation assembly 12. Although a hydraulic fracturing system 136 is shown and described herein for the purpose of providing an example, other wellsite operations are contemplated as will be understood by those skilled in the art. In some embodiments, the power generation assembly 12 may enhance power supply efficiency and/or reduce undesirable greenhouse gas emissions to the environment, such as, for example, carbon dioxide emissions, while supplying power sufficient to perform the wellsite operation 22, such as well construction, well completion, and/or well production, which may include a hydraulic fracturing operation.

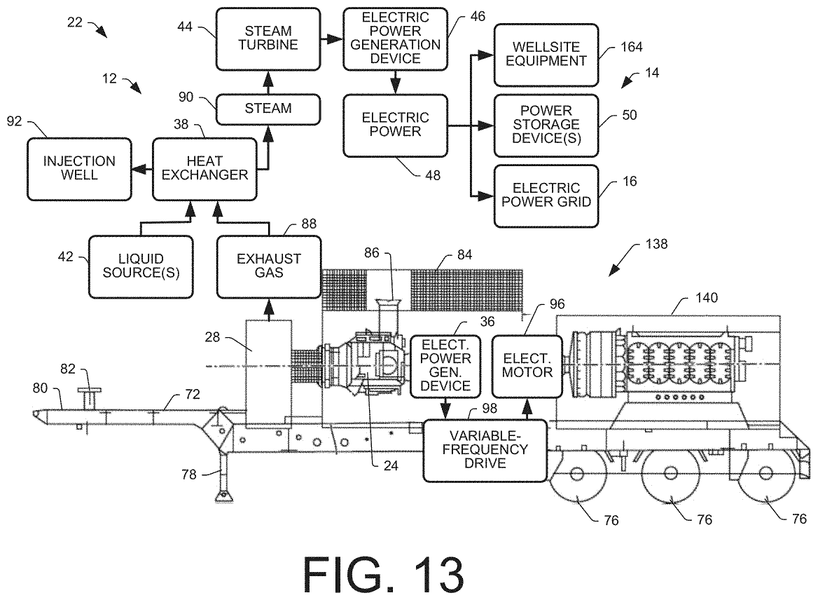

As shown in FIG. 10, some embodiments of the hydraulic fracturing system 136 may include a plurality of hydraulic fracturing units 138. In some embodiments, one or more of the hydraulic fracturing units 138 may include a hydraulic fracturing pump 140 driven by a prime mover, such as an internal combustion engine. For example, the prime movers may include GTEs 24 or reciprocating-piston engines. In some embodiments, each of the hydraulic fracturing units 138 may include a directly-driven turbine (DDT) hydraulic fracturing pump 140, in which the hydraulic fracturing pump 140 is connected to one or more GTEs 24 that supply power to the respective hydraulic fracturing pump 140 for supplying fracturing fluid at high pressure and high flow rates to a formation. For example, the GTE 24 may be connected to a respective hydraulic fracturing pump 140 via a speed reduction gear 30 (e.g., a reduction transmission) connected to a drive shaft, which, in turn, is connected to a driveshaft or input flange of a respective hydraulic fracturing pump 140, which may be a reciprocating hydraulic fracturing pump. Other types of engine-to-pump arrangements are contemplated, for example, as described herein with respect to FIG. 13.

In some embodiments, one or more of the GTEs 24 may be a dual-fuel or bi-fuel GTE, for example, capable of being operated using of two or more different types of fuel, such as natural gas and diesel fuel, although other types of fuel are contemplated. For example, a dual-fuel or bifuel GTE may be capable of being operated using a first type of fuel, a second type of fuel, and/or a combination of the first type of fuel and the second type of fuel. For example, the fuel may include gaseous fuels, such as, for example, compressed natural gas (CNG), natural gas, field gas, pipeline gas, methane, propane, butane, and/or liquid fuels, such as, for example, diesel fuel (e.g., #2 diesel), bio-diesel fuel, biofuel, alcohol, gasoline, gasohol, aviation fuel, and other fuels, as will be understood by those skilled in the art. Gaseous fuels may be supplied by CNG bulk vessels, a gas compressor, a liquid natural gas vaporizer, line gas, and/or well-gas produced natural gas. Other types and associated fuel supply sources are contemplated. The one or more prime movers may be operated to provide horsepower to drive the speed reduction gear 30 connected to one or more of the hydraulic fracturing pumps 140 to fracture a formation during a well stimulation project or fracturing operation.

In some embodiments, the fracturing fluid may include, for example, water, proppants, and/or other additives, such as thickening agents and/or gels. For example, proppants may include grains of sand, ceramic beads or spheres, shells, and/or other particulates, and may be added to the fracturing fluid, along with gelling agents to create a slurry as will be understood by those skilled in the art. The slurry may be forced via the hydraulic fracturing pumps 140 into the formation at rates faster than can be accepted by the existing pores, fractures, faults, or other spaces within the formation. As a result, pressure in the formation may build rapidly to the point where the formation fails and begins to fracture. By continuing to pump the fracturing fluid into the formation, existing fractures in the formation may be caused to expand and extend in directions away from a well bore, thereby creating additional flow paths for hydrocarbons to flow to the well. The proppants may serve to prevent the expanded fractures from closing or may reduce the extent to which the expanded fractures contract when pumping of the fracturing fluid is ceased. Once the well is fractured, large quantities of the injected fracturing fluid may be allowed to flow out of the well, and the water and any proppants not remaining in the expanded fractures may be separated from hydrocarbons produced by the well to protect downstream equipment from damage and corrosion. In some instances, the production stream of hydrocarbons may be processed to neutralize corrosive agents in the production stream resulting from the fracturing process.

the hydraulic fracturing system 136 may include one or more water tanks 142 for supplying water for fracturing fluid, one or more chemical additive units 144 for supplying gels or agents for adding to the fracturing fluid, and one or more proppant tanks 146 (e.g., sand tanks) for supplying proppants for the fracturing fluid. The example hydraulic fracturing system 136 shown also includes a hydration unit 148 for mixing water from the water tanks 142 and gels and/or agents from the chemical additive units 144 to form a mixture, for example, gelled water. The example shown also includes a blender 150, which receives the mixture from the hydration unit 148 and proppants via conveyers 152 from the proppant tanks 146. The blender 150 may mix the mixture and the proppants into a slurry to serve as fracturing fluid for the hydraulic fracturing system 136. Once combined, the slurry may be discharged through low-pressure hoses, which convey the slurry into two or more low-pressure lines in a fracturing manifold 154. In the example shown, the low-pressure lines in the fracturing manifold 154 may feed the slurry to the hydraulic fracturing pumps 140 through low-pressure suction hoses as will be understood by those skilled in the art.

The hydraulic fracturing pumps 140, driven by the respective GTEs 24, discharge the slurry (e.g., the fracturing fluid including the water, agents, gels, and/or proppants) at high flow rates and/or high pressures through individual high-pressure discharge lines into one or more high-pressure flow lines, sometimes referred to as “missiles,” on the fracturing manifold 154. The flow from the high-pressure flow lines may be combined at the fracturing manifold 154, and one or more of the high-pressure flow lines may provide fluid flow to a manifold assembly 156, sometimes referred to as a “goat head.” The manifold assembly 156 delivers the slurry into a wellhead manifold 158. The wellhead manifold 158 may be configured to selectively divert the slurry to, for example, one or more wellheads or wellbores 160 via operation of one or more valves. Once the fracturing process is ceased or completed, flow returning from the fractured formation discharges into a flowback manifold, and the returned flow may be collected in one or more flowback tanks as will be understood by those skilled in the art.

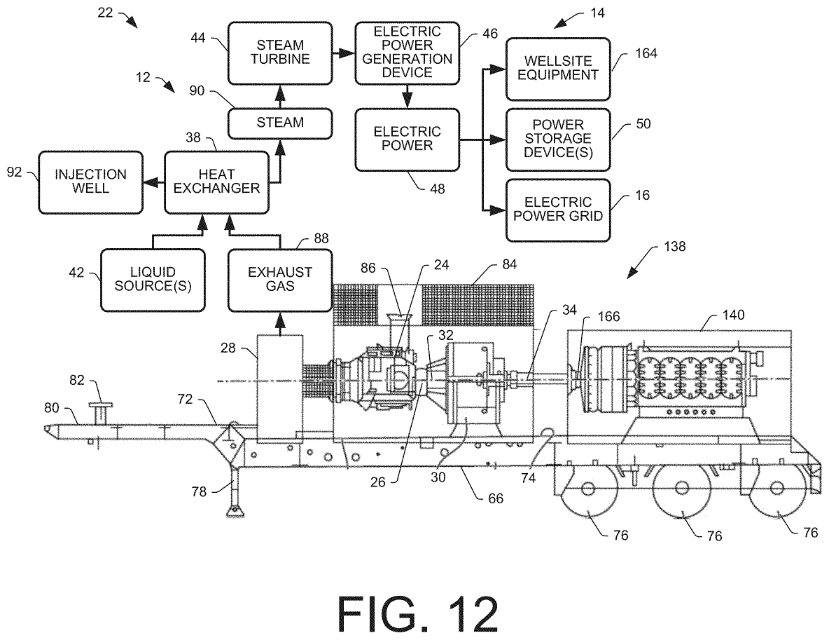

As schematically depicted in FIG. 10, one or more of the components of the hydraulic fracturing system 136 may be configured to be portable, so that the hydraulic fracturing system 136 may be transported to a wellsite, quickly assembled, operated for a relatively short period of time, at least partially disassembled, and transported to another location of another wellsite for use. For example, the components may be connected to and/or supported on a mobile chassis 66, for example, a trailer and/or a support incorporated into a truck, so that they may be easily transported between wellsites. In some embodiments, the GTE 24, the speed reduction gear 30, and/or the hydraulic fracturing pump 140 may be connected to the mobile chassis 66. For example, the mobile chassis 66 may include a platform 74 (see, e.g., FIGS. 12 and 13), the speed reduction gear 30 may be connected to the platform 74, and the GTE 24 may be connected to the speed reduction gear 30.

As shown in FIG. 10, some embodiments of the hydraulic fracturing system 136 may include one or more fuel supplies 54 for supplying the GTEs 24 and any other fuel-powered components of the hydraulic fracturing system 136, such as auxiliary equipment, with fuel. The fuel supplies 54 may include gaseous fuels, such as compressed natural gas (CNG), natural gas, field gas, pipeline gas, methane, propane, butane, and/or liquid fuels, such as, for example, diesel fuel (e.g., #2 diesel), bio-diesel fuel, biofuel, alcohol, gasoline, gasohol, aviation fuel, and other fuels as will be understood by those skilled in the art. Gaseous fuels may be supplied by CNG bulk vessels, such as fuel tanks coupled to trucks, a gas compressor, a liquid natural gas vaporizer, line gas, and/or well-gas produced natural gas. The fuel may be supplied to the hydraulic fracturing units 138 by one of more fuel lines 56 supplying the fuel to a fuel manifold 58 and unit fuel lines 60 between the fuel manifold 58 and the hydraulic fracturing units 138. Other types and associated fuel supply sources and arrangements are contemplated as will be understood by those skilled in the art.

As shown in FIG. 10, some embodiments also may include one or more data centers 62 configured to facilitate receipt and transmission of data communications related to operation of one or more of the components of the hydraulic fracturing system 136. Such data communications may be received and/or transmitted via hard-wired communications cables and/or wireless communications, for example, according to known communications protocols. For example, the data centers 62 may contain at least some components of a hydraulic fracturing control assembly, such as a supervisory controller configured to receive signals from components of the hydraulic fracturing system 136 and/or communicate control signals to components of the hydraulic fracturing system 136, for example, to at least partially control operation of one or more components of the hydraulic fracturing system 136, such as, for example, the power generation assembly 12, including the GTEs 24, the speed reduction gears 30, and/or the hydraulic fracturing pumps 140 of the hydraulic fracturing units 138, the chemical additive units 144, the hydration units 148, the blender 150, the conveyers 152, the fracturing manifold 154, the manifold assembly 156, the wellhead manifold 158, and/or any associated valves, pumps, and/or other components of the hydraulic fracturing system 136.

As shown in FIG. 10, at least part of the hydraulic fracturing system 136 may be incorporated into the example power generation assembly 12. In the embodiment shown in FIG. 10, the GTE 24 is a gas turbine engine positioned to convert fuel into mechanical power 162. The GTE 24 shown may include an exhaust gas duct 28 (see, e.g., FIGS. 12 and 13) positioned to receive exhaust gas 88 during operation of the GTE 24. The example power generation assembly 12 shown also includes a heat exchanger 38 positioned to receive the exhaust gas 88 during operation of the GTE 24. The heat exchanger 38 may include an exhaust gas inlet positioned to receive the exhaust gas 88 from the exhaust gas duct 28, and a liquid inlet positioned to receive liquid from one or more liquid source(s) 42. The heat exchanger 38 may be positioned to convert liquid into steam (see, e.g., steam 90 in FIGS. 12 and 13) via heat from the exhaust gas 88. As shown, the power generation assembly 12, in some embodiments, may include a steam turbine 44 positioned to receive steam 90 from the heat exchanger 38 and to convert energy from the steam 90 into mechanical power. In some embodiments, an electric power generation device 46 may be connected to the steam turbine 44 and positioned to convert the mechanical power from the steam turbine 44 into electric power 48.

As shown in FIG. 10 and discussed herein, in some embodiments, at least a portion of the mechanical power supplied by the GTE 24 may be used to power wellsite equipment 164 (e.g., other than the speed reduction gear 30 to which it is connected). The electric power 48 generated by the electric power generation device 46 may be used to supply electric power for operation of wellsite equipment 164 (e.g., electrically-powered wellsite equipment), to supply electric power 48 for storage in one or more power storage devices 50, such as, for example, rechargeable batteries and/or capacitors, and/or to supply an electric power grid 16. Although the example power storage device(s) 50 shown in FIGS. 10, 12, 13, 15, and 18 may be electric power storage device(s), other types of power storage devices are contemplated, such as, for example, chemical power storage devices (e.g., fuels and/or liquid/chemical power storage devices) and/or mechanical power storage devices (e.g., kinetic energy storage devices, flywheels, etc.). As shown in FIG. 10, in some embodiments, at least a portion of the exhaust gas 88 (e.g., exhaust gas not used for generating steam) may be supplied to an injection well 92 for disposal. In some embodiments, exhaust gas 88 downstream relative to the heat exchanger 38 may be supplied to the injection well 92.

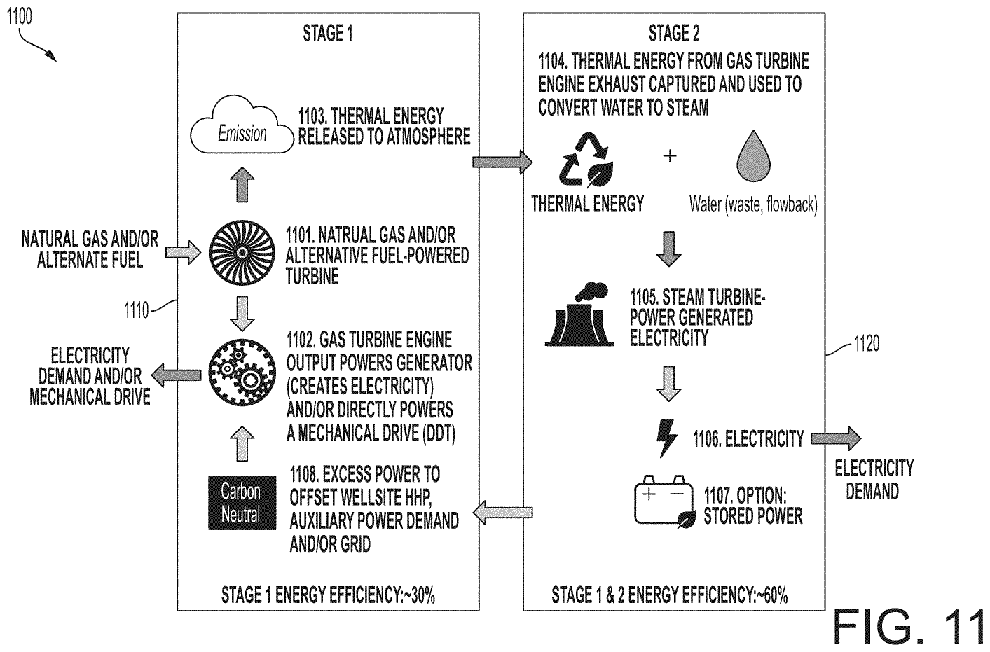

FIG. 11 is a diagrammatic representation of example power generation, use, conversion, recovery, and storage having two example stages according to some embodiments of the disclosure. First stage 1110 of an example wellsite operation, which may be an example hydraulic fracturing operation includes, at 1101, supplying natural gas and/or an alternative fuel to a gas turbine engine. The alternative fuels may include liquid fuels, such as diesel, kerosene, mixed gas (e.g., hydrogen/natural gas), and/or other fuels described herein. At 1102, the gas turbine engine, to meet an electricity demand and/or a mechanical-drive demand, supplies a power output to power a generator and/or a mechanical drive, such as a directly-driven turbine (DDT) hydraulic fracturing pump, for example, as described herein. At 1103, thermal energy in the form of exhaust gas resulting from operation of the gas turbine engine is released to the atmosphere. As noted herein, the exhaust gas may include undesirable emissions to the environment, such as, for example, carbon dioxide, particulates, and other undesirable oxides, depending at least in part on the fuel supplied to the gas turbine engine and/or any after-treatment following combustion. As noted in FIG. 11, a typical expected energy efficiency for first stage 1101 might be expected to be about 30%.

As shown in FIG. 11, a second stage 1120 of the example wellsite operation includes, at 1104, thermal energy from the exhaust gas from operation of the gas turbine engine being captured and used to convert water to steam, instead of all the thermal energy in the exhaust gas being released to the atmosphere (as at 1103). For example, as shown, water from one or more of various water sources may be heated using the thermal energy to convert the water to steam. The water may be provided by wastewater and/or flowback water, which may be present at the wellsite operation. At 1105, a steam turbine may be used to generate electricity using the steam from 4 and/or other steam sources. For example, the steam turbine may be connected to an electric generator to supply mechanical power to the electric generator to convert mechanical power into electric power at 1106. The electric power may be used to meet electric power demands associated with the wellsite operation, for example, to drive electrically-powered wellsite equipment. At 1107, the electric power may be optionally stored, for example, in electric power storage devices, such as, for example, batteries and/or capacitors. At 1108, excess power may be supplied to wellsite equipment (e.g., mechanical power and/or electric power) to supplement or meet power demands, including for operating auxiliary equipment, and/or excess electric power may be supplied to an electric power grid. As noted in FIG. 11, a typical expected energy efficiency for combined stages 1110 and 1120 might be expected to be about 60%, or about double the expected energy efficiency for first stage 1110 alone.

FIG. 12 is a schematic side view of an example hydraulic fracturing unit according to some embodiments of the disclosure. The speed reduction gear 30 may include a transmission input shaft 32 connected to a gas turbine output shaft 26 (e.g., a turbine output shaft), such that the transmission input shaft 32 rotates at the same rotational speed as the gas turbine output shaft 26. The speed reduction gear 30 may also include a transmission output shaft 34 positioned to be driven by the transmission input shaft 32 at a different rotational speed than the transmission input shaft 32. In some embodiments, the speed reduction gear 30 may be a reduction transmission including a reduction gear assembly, which results in the transmission output shaft 34 having a relatively slower rotational speed than the transmission input shaft 32. The speed reduction gear 30 may include a continuously-variable transmission, an automatic transmission including one or more planetary gear trains, a transmission shiftable between different ratios of input-to-output, etc., or any other suitable of types of transmissions.

The hydraulic fracturing pump 140 may be, for example, a reciprocating fluid pump. Other types of fluid pumps are contemplated. In some embodiments, the hydraulic fracturing pump 140 may include a pump drive shaft 166 connected to the transmission output shaft 34, such that the transmission output shaft 34 drives the pump drive shaft 166 at a desired rotational speed. For example, the transmission output shaft 34 may include an output shaft connection flange, and the pump drive shaft 166 may include a drive shaft connection flange, and the output shaft connection flange and the drive shaft connection flange may be coupled to one another, for example, directly connected to one another. In some embodiments, the transmission output shaft 34 and the pump drive shaft 166 may be connected to one another via couplings, such as a universal joint and/or a torsional coupling.

As shown in FIG. 12, in some embodiments, the mobile chassis 66 may be, or include, a trailer 72 including the platform 74 for supporting components of the hydraulic fracturing unit 138, one or more pairs of wheels 76 facilitating movement of the trailer 72, a pair of retractable supports 78 to support the hydraulic fracturing unit 138 during use, and a tongue 80 including a coupler 82 for connecting the trailer 72 to a truck for transport of the hydraulic fracturing unit 138 between wellsites to be incorporated into a hydraulic fracturing system 136 of a fracturing operation.

As shown in FIGS. 10, 12, and 13, some embodiments of the hydraulic fracturing unit 138 may include an enclosure 84 connected to and supported by the mobile chassis 66. In some embodiments, as shown in FIG. 10, the GTE 24 may be connected to the speed reduction gear 30 via the gas turbine output shaft 26 and the transmission input shaft 32, both of which may be substantially contained within the enclosure 84. The GTE 24 may include an air intake duct 86 and an exhaust gas duct 28 passing through walls of the enclosure 84 and connected to the GTE 24. The GTE 24 may be connected to the hydraulic fracturing pump 140 via the speed reduction gear 30, with the transmission output shaft 34 connected to the pump drive shaft 166, for example, as explained herein.

As shown in FIG. 12, at least part of the hydraulic fracturing system 136 may be incorporated into the example power generation assembly 12. In the embodiment shown in FIG. 12, the GTE 24 is positioned to convert fuel into mechanical power 162. The exhaust gas duct 28 of the GTE 24 is positioned to receive exhaust gas 88 during operation of the GTE 24. The example power generation assembly 12 shown also includes a heat exchanger 38 positioned to receive the exhaust gas 88 during operation of the GTE 24. The heat exchanger 38 may include an exhaust gas inlet positioned to receive the exhaust gas 88 from the exhaust gas duct 28, and a liquid inlet positioned to receive liquid from one or more liquid source(s) 42. The heat exchanger 38 may be positioned to convert liquid into steam 90 via heat from the exhaust gas 88. As shown, the power generation assembly 12, in some embodiments, may include a steam turbine 44 positioned to receive steam 88 from the heat exchanger 38 and to convert energy from the steam 88 into mechanical power. In some embodiments, an electric power generation device 46 may be connected to the steam turbine 44 and positioned to convert the mechanical power from the steam turbine 44 into electric power 48.

As shown in FIG. 12 and discussed herein, in some embodiments, at least a portion of the mechanical power 162 supplied by the GTE 24 may be used to power wellsite equipment 164 (see, e.g., FIG. 10, for example, other than the speed reduction gear 30 to which it is connected). The electric power 48 generated by the electric power generation device 46 may be used to supply electric power for operation of wellsite equipment 164 (e.g., electrically-powered wellsite equipment), to supply electric power 164 for storage in one or more power storage devices 50, such as, for example, rechargeable batteries and/or capacitors, and/or to supply an electric power grid 16. As shown in FIG. 12, in some embodiments, at least a portion of the exhaust gas 88 (e.g., exhaust gas not used for generating steam) may be supplied to an injection well 92 for disposal. In some embodiments, exhaust gas 88 downstream relative to the heat exchanger 38 may be supplied to the injection well 92.

FIG. 13 is a schematic side view of another example hydraulic fracturing unit 138 incorporated into an example power generation assembly 12, according to embodiments of the disclosure. The embodiment shown in FIG. 13 is similar to the embodiment shown in FIG. 12, except that instead of the GTE 24 being connected to a speed reduction gear as shown in FIG. 12, in the embodiment shown in FIG. 13, the GTE 24 is connected to an electric power generation device 36, which, in turn, is connected to an electric motor 96 positioned to drive the hydraulic fracturing pump 140. In this example manner, the hydraulic fracturing pump 140 is electrically-driven to pump hydraulic fracturing fluid into a fracturing manifold, for example, as described herein.

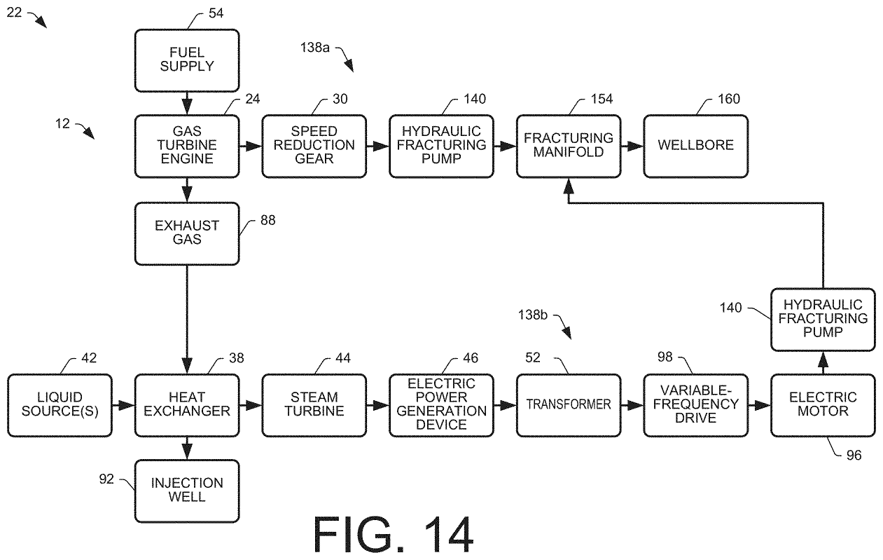

FIG. 14 is a block diagram of an example power generation assembly 12 for an example wellsite operation 22 including an example mechanically-driven hydraulic fracturing unit 138a and an example electrically-driven hydraulic fracturing unit 138b, according to embodiments of the disclosure. As shown in FIG. 14, the power generation assembly 12 includes a GTE 24 positioned to convert fuel from a fuel supply 54 into mechanical power. The GTE 24 includes an exhaust gas duct 28 (see, e.g., FIGS. 12 and 13) positioned to receive exhaust gas 88 during operation of the GTE 24. The example power generation assembly 12 includes a heat exchanger 38 positioned to receive the exhaust gas 88 during operation of the GTE 24, and the heat exchanger 38 includes an exhaust gas inlet positioned to receive exhaust gas 88 from the exhaust gas duct 28 and a liquid inlet positioned to receive liquid from one or more liquid source(s) 42. In some embodiments, the heat exchanger 38 may be positioned to convert liquid into steam (see, e.g., steam 90 in FIGS. 12 and 13) via heat from the exhaust gas 88. As shown in FIG. 14, in some embodiments, the power generation assembly 12 may further include a steam turbine 44 positioned to receive steam from the heat exchanger 38 and to convert energy from the steam into mechanical power. Some embodiments may further include an electric power generation device 46 connected to the steam turbine 44 and positioned to convert the mechanical power from the steam turbine 44 into electrical power. For example, the electric motor 96 may be in electrical communication with the electric power generation device 46. The electric motor 960 may include a motor output shaft, and the electrically-driven hydraulic fracturing unit 138b may include a second hydraulic fracturing pump 168 including a pump input shaft connected to the motor output shaft. The second hydraulic fracturing pump 168 may be positioned to pump fracturing fluid into the fracturing manifold 154, for example, as shown.

As shown in FIG. 14, in some embodiments, the electrically-driven hydraulic fracturing unit 138b may include a variable-frequency drive 98 in electrical communication with the electric power generation device 46 and the electric motor 960. The variable-frequency drive 98 may be configured to control voltage supplied to the electric motor 96. In some embodiments, the electrically-driven hydraulic fracturing unit 138b may include a transformer 52 in electrical communication with the electric power generation device 46 and the variable-frequency drive 98. In some embodiments, the transformer 52 may be configured to at least partially control electrical power supplied to the variable-frequency drive 98.

In some embodiments consistent with FIG. 14, a plurality of GTEs 24 may be used to mechanically drive respective hydraulic fracturing pumps 140 via respective speed reduction gears 30, which may be speed reduction gearboxes. Heat from the exhaust gas 88 may be at least partially recovered via one or more heat exchangers 38, which may be heat recovery steam generators, to provide steam to drive a steam turbine 44 to supply mechanical power 162 to drive an electric power generation device 46 to generate electric power, which may be used to drive hydraulic fracturing pumps 140 via electric motors 96 and/or other electrically-powered wellsite equipment 164 In some embodiments, liquid source(s) 58 (e.g., water sources) for steam generation may include, but are not limited to, flowback water, produced water, geothermal water, wastewater, and/or any other water of liquid readily available at the wellsite operation 22. In such embodiments, some or all generated power may be used to provide hydraulic horsepower for hydraulic fracturing fluid injection downhole. In some embodiments, exhaust gas 88, after being used for heat for the heat exchanger 38, may be injected into an injection well 92, for example, to at least partially reduce the greenhouse gas emission to zero.

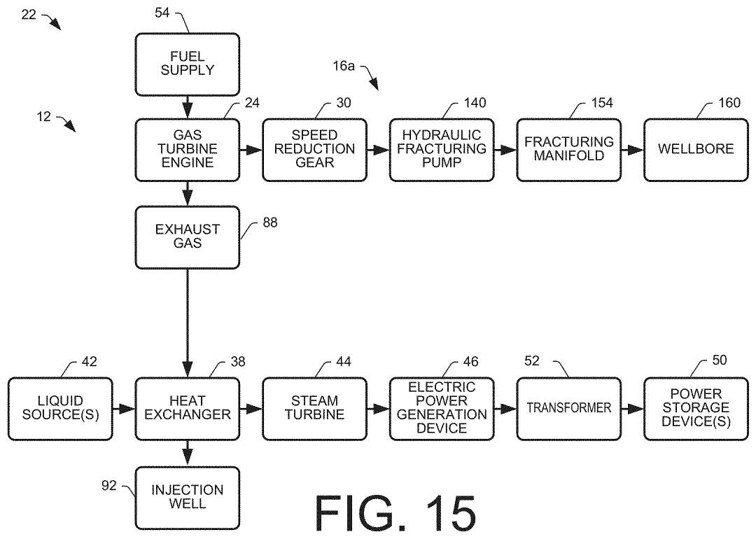

FIG. 15 is a block diagram of an example power generation assembly 12 for an example wellsite operation 22 including an example mechanically-driven hydraulic fracturing unit 138a and example electric power storage, according to embodiments of the disclosure. The embodiment shown in FIG. 15 is similar to the embodiment shown in FIG. 14, except that in the embodiment shown in FIG. 15, instead of an electrically-driven fracturing unit 138b as shown in FIG. 14, the power generation assembly 12 shown in FIG. 15 includes one or more power storage device(s) 50, which may include, for example, one or more rechargeable batteries and/or one or more capacitors.

As shown in FIG. 15, the power generation assembly 12 may include a mechanically-driven hydraulic fracturing unit 138a and one or more power storage device(s) 50 in electrical communication with the electric power generation device 46. Some embodiments may include a transformer 52 in electrical communication with the electric power generation device 46 and the one or more power storage device(s) 50, and positioned to transfer electrical power from the electric power generation device(s) 46 to one or more of the power storage device(s) 50.

In some embodiments consistent with FIG. 15, a plurality of GTEs 24 may be used to mechanically drive respective hydraulic fracturing pumps 140 via respective speed reduction gears 30, which may be speed reduction gearboxes. Heat from the exhaust gas 88 may be at least partially recovered via one or more heat exchangers 38, which may be heat recovery steam generators, to provide steam (see, e.g., steam 90 in FIGS. 12 and 13) to drive a steam turbine 44 to supply mechanical power to drive an electric power generation device 46 to generate electric power, which may be stored in the power storage device(s) 50, which may include one or more rechargeable batteries and/or capacitors. In some embodiments, liquid source(s) 42 (e.g., water sources) for steam generation may include, but are not limited to, flowback water, produced water, geothermal water, wastewater, and/or any other water or liquid readily available at the wellsite operation 22. In such embodiments, all generated power may be used to provide hydraulic horsepower for hydraulic fracturing fluid injection downhole. In some embodiments, exhaust gas 88, after being used for heat for the heat exchanger 38, may be injected into an injection well 92, for example, to at least partially reduce the greenhouse gas emission toward zero.

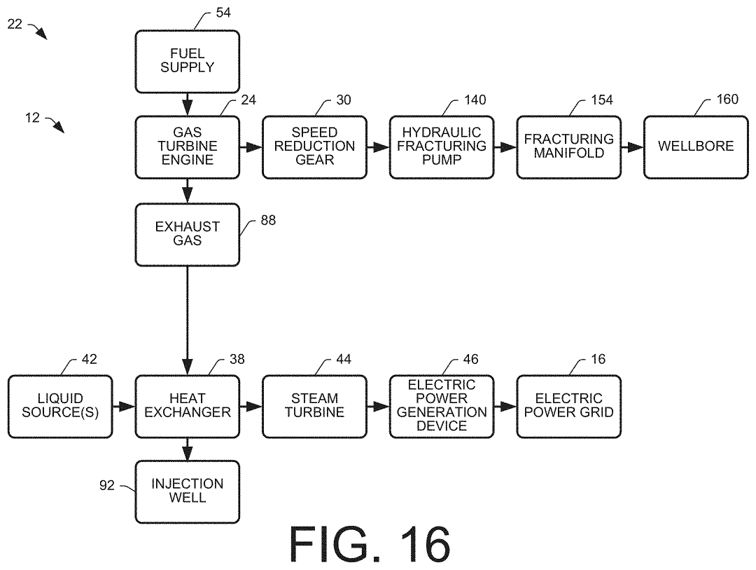

FIG. 16 is a block diagram of an example power generation assembly 12 for an example wellsite operation 22 including an example mechanically-driven hydraulic fracturing unit 138a and an example supply of electric power to an electric power grid 16 according to some embodiments of the disclosure. The embodiment shown in FIG. 16 is similar to the embodiment shown in FIG. 15, except that in the embodiment shown in FIG. 16, instead of power storage device(s) 50 as shown in FIG. 15, the power generation assembly 12 shown in FIG. 16 supplies electric power to an electric power grid 16. As shown in FIG. 16, the power generation assembly 12 may include a mechanically-driven hydraulic fracturing unit 138a and an electric power grid 16 to which electric power may be supplied.

As shown in FIG. 16, the power generation assembly 12 may include a mechanically-driven hydraulic fracturing unit 138a and the electrical power grid 16. For example, some embodiments may include a grid connection terminal in electrical communication with the electric power generation device 46 and an electric power grid 16 and positioned to transfer electrical power from the electric power generation device 46 to the electric power grid 16.

In some embodiments consistent with FIG. 16, a plurality of GTEs 24 may be used to mechanically drive respective hydraulic fracturing pumps 140 via respective speed reduction gears 30, which may be speed reduction gearboxes. Heat from the exhaust gas 88 may be at least partially recovered via one or more heat exchangers 38, which may be heat recovery steam generators, to provide steam (see, e.g., steam 90 in FIGS. 12 and 13) to drive a steam turbine 44 to supply mechanical power to drive an electric power generation device 46 to generate electric power, which may be used to supply an electric power grid 16, which may include a local electric power grid, a utility grid, and/or a micro-grid. In some embodiments, liquid source(s) 42 (e.g., water sources) for steam generation may include, but are not limited to, flowback water, produced water, geothermal water, wastewater, and/or any other water or liquid readily available at the wellsite operation 22. In such embodiments, some or all generated power may be used to provide hydraulic horsepower for hydraulic fracturing fluid injection downhole. In some embodiments, exhaust gas 88, after being used for heat for the heat exchanger 38, may be injected into an injection well 92, for example, to at least partially reduce the greenhouse gas emission toward zero.

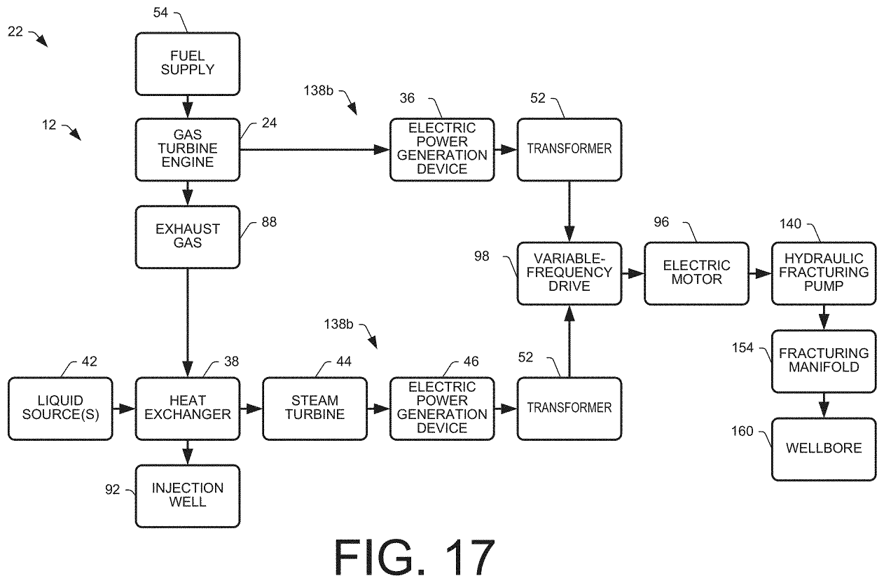

FIG. 17 is a block diagram of an example wellsite operation 22, including an example electrically-driven hydraulic fracturing unit 138b having two electric power sources, according to embodiments of the disclosure. The embodiment shown in FIG. 17 is similar to the embodiment shown in FIG. 15, except that in the embodiment shown in FIG. 17, instead of including a mechanically-driven hydraulic fracturing unit 138a as shown in FIG. 15, the power generation assembly 12 shown in FIG. 17 includes two electrically-driven hydraulic fracturing units 138b supplied with electric power via operation of both the GTE 24 and the steam turbine 44.

As shown in FIG. 17, the power generation assembly 12 may include a GTE 24 connected to an electric power generation device 36. For example, the electric power generation device 36 may include a generator input shaft connected to the gas turbine output shaft 26 and configured to convert mechanical power supplied by the GTE 24 into electrical power. The example power generation assembly 12 shown in FIG. 17, also may include an electric motor 96 in electrical communication with the electric power generation device 36. The electric motor 96 may include a motor output shaft, and the hydraulic fracturing pump 140 may include a pump input shaft connected to the motor output shaft. As shown, the hydraulic fracturing pump 140 may be positioned to pump fracturing fluid into the fracturing manifold 154 and into the wellbore 160.

As shown in FIG. 17, a variable-frequency drive 98 in electrical communication with the electric motor 96 and the electric power generation device 36 may be provided. The variable-frequency drive 98 may be configured to control voltage supplied to the electric motor 96. Some embodiments may include a transformer 52 in electrical communication with the variable-frequency drive 98 and the electric power generation device 36. The transformer 52 may be configured to at least partially control electrical power supplied to the variable-frequency drive 98.

In some embodiments consistent with FIG. 17, one or more GTEs 24 may be used to supply mechanical power to respective electric power generation device 36, which may generate electricity to combine with electricity generated by the steam turbine 44, which generates steam (see, e.g., steam 90 in FIGS. 12 and 13) via heat from the exhaust gas 88 generated by the GTEs 24 during operation. The combined electric power may be used to power various wellsite equipment 164 (e.g., electrically-powered wellsite equipment), such as hydraulic fracturing pumps via electric motors, and/or other electric devices. In some embodiments, liquid source(s) 42 (e.g., water sources) for steam generation may include, but are not limited to, flowback water, produced water, geothermal water, wastewater, and/or any other water or liquid readily available at the wellsite operation 22. In such embodiments, some or all generated power may be used to provide hydraulic horsepower for fluid injection downhole. In some embodiments, exhaust gas 88, after being used for heat for the heat exchanger 38, may be injected into an injection well 92, for example, to at least partially reduce the greenhouse gas emission toward zero.

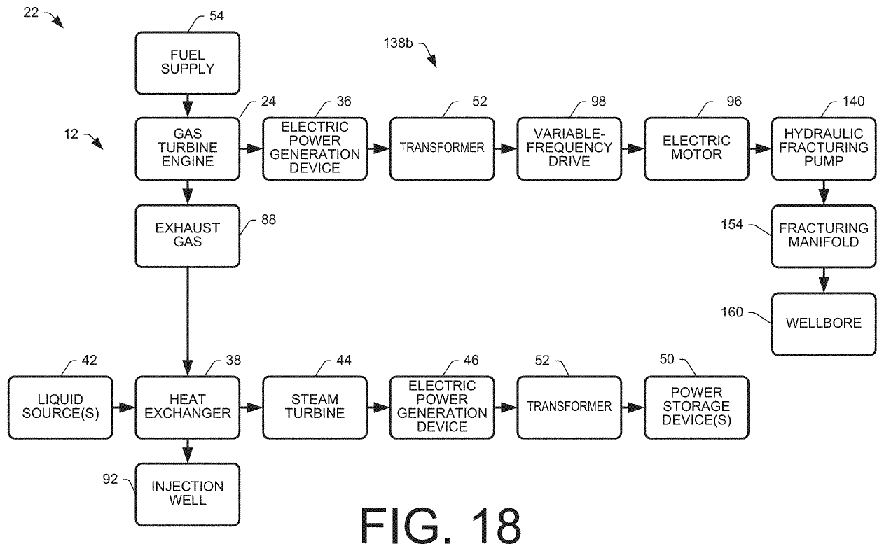

FIG. 18 is a block diagram of an example power generation assembly 12 for an example wellsite operation 22 including an example electrically-driven hydraulic fracturing unit 138b and example electric power storage according to some embodiments of the disclosure. The embodiment shown in FIG. 18 is similar to the embodiment shown in FIG. 17, except that in the embodiment shown in FIG. 18, instead of including an electrically-driven hydraulic fracturing unit 138b supplied with electric power by heat of the exhaust gas 88 and the steam turbine 44 as shown in FIG. 17, the power generation assembly 12 shown in FIG. 18 includes a single electrically-driven hydraulic fracturing unit 138b supplied with electric power via operation of the GTE 24 and the electric power generation device 36, and one or more power storage device(s) 50. For example, similar to the embodiment shown in FIG. 15, the power generation assembly 12 shown in FIG. 18 may include one or more power storage device(s) 50 in electrical communication with the electric power generation device 46. Some embodiments may include a transformer 52 in electrical communication with the electric power generation device 46 and the one or more power storage device(s) 50, and positioned to transfer electrical power from the electric power generation device 46 to one or more of the power storage device(s) 50.

In some embodiments consistent with FIG. 18, one or more GTEs 24 may be used to generate electricity via respective electric power generation devices 36 to supply electric power to electrically-powered wellsite equipment 164, such as for example, hydraulic fracturing pumps 140 driven by respective electric motors 96 and/or other electrically-powered devices. Heat from the exhaust gas 88 may be at least partially recovered via one or more heat exchangers 38, which may be heat recovery steam generators, to provide steam 90 to drive a steam turbine 44 to supply mechanical power to drive an electric power generation device 46 to generate electric power, which may be stored in power storage device(s) 50, which may include one or more rechargeable batteries and/or capacitors. In some embodiments, liquid source(s) 42 (e.g., water) for steam generation may include, but are not limited to, flowback water, produced water, geothermal water, wastewater, and/or any other water of liquid readily available at the wellsite operation 22. In such embodiments, some or all generated power may be used to provide hydraulic horsepower for fluid injection downhole. In some embodiments, exhaust gas 88, after used for heat for the heat exchanger 38 may be injected into an injection well 92, for example, to at least partially reduce the greenhouse gas emission toward zero.

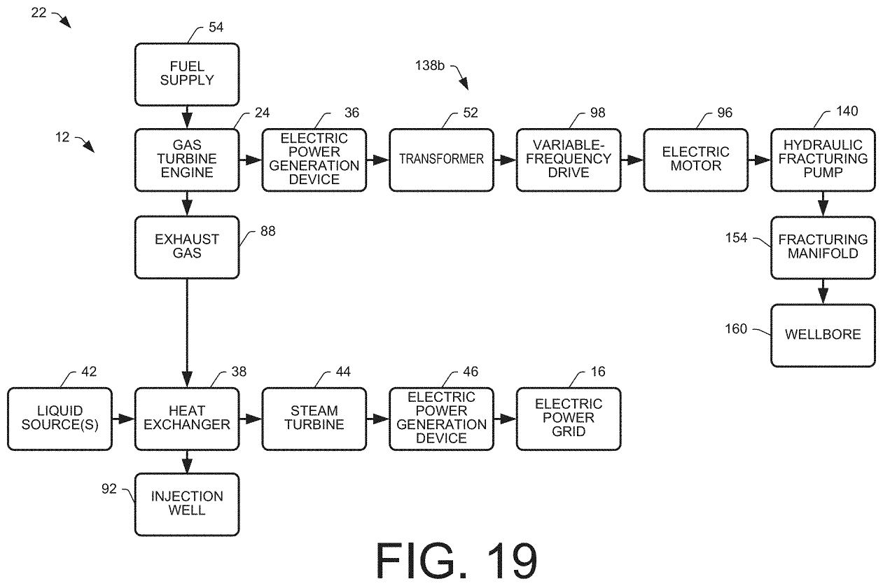

FIG. 19 is a block diagram of an example power generation assembly 12 for an example wellsite operation 22 including an example electrically-driven hydraulic fracturing unit 138b and example supply of electric to an electric power grid 16 according to some embodiments of the disclosure. The embodiment shown in FIG. 19 is similar to the embodiment shown in FIG. 18, except that in the embodiment shown in FIG. 19, instead of power storage device(s) 50 as shown in FIG. 18, the power generation assembly 12 shown in FIG. 19 supplies electric power to an electric power grid 16. As shown in FIG. 19, the power generation assembly 12 may include an electrically-driven hydraulic fracturing unit 138b and an electric power grid 16 to which electric power may be supplied.

As shown in FIG. 19, the power generation assembly 12 may include an electrically-driven hydraulic fracturing unit 138b and the electrical power grid 16. For example, some embodiments may include a grid connection terminal in electrical communication with the electric power generation device 46 and an electric power grid 16 and positioned to transfer electrical power from the electric power generation device 46 to the electric power grid 16.

In some embodiments consistent with FIG. 19, one or more GTEs 24 may be used to generate electricity via respective electric power generation devices 36 to supply electric power to electrically-powered wellsite equipment 164, such as, for example, hydraulic fracturing pumps 140 driven by respective electric motors 96 and/or other electrically-powered devices. Heat from the exhaust gas 88 may be at least partially recovered via one or more heat exchangers 38, which may be heat recovery steam generators, to provide steam (see, e.g., steam 90 in FIGS. 12 and 13) to drive a steam turbine 44 to supply mechanical power to drive an electric power generation device 46 to generate electric power. The generated electric power may be used to supply an electric power grid 16, which may include a local electric power grid, a utility grid, and/or a micro-grid. In some embodiments, liquid source(s) 42 (e.g., water sources) for steam generation may include, but are not limited to, flowback water, produced water, geothermal water, wastewater, and/or any other water or liquid readily available at the wellsite operation 22. In such embodiments, some or all generated power may be used to provide hydraulic horsepower for hydraulic fracturing fluid injection downhole. In some embodiments, exhaust gas 88, after being used for heat for the heat exchanger 38 may be injected into an injection well 92, for example, to at least partially reduce the greenhouse gas emission toward zero.

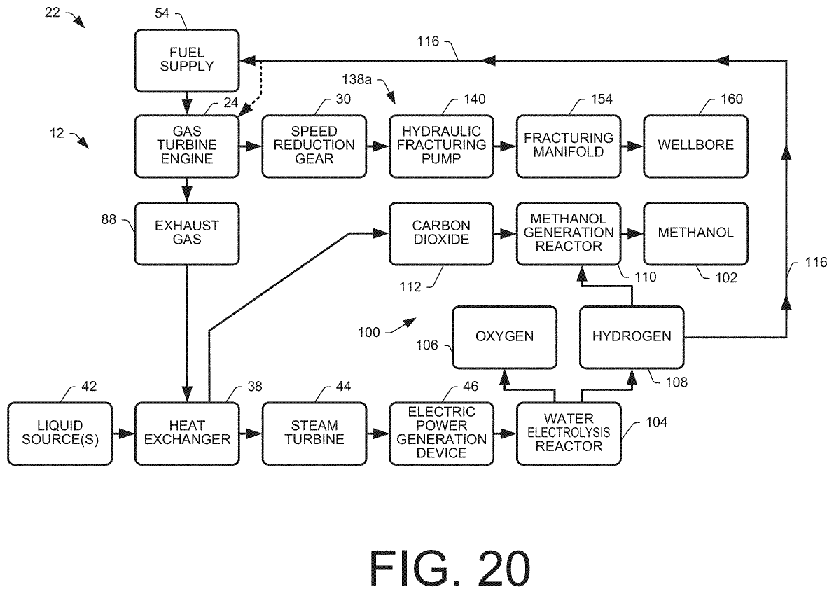

FIG. 20 is a block diagram of an example power generation assembly 12 for an example wellsite operation 22 including an example mechanically-driven hydraulic fracturing unit 138a and an example methanol conversion assembly 100 according to some embodiments of the disclosure. In the embodiment shown in FIG. 20, the power generation system 12 includes a mechanically-driven hydraulic fracturing unit 138a and a methanol conversion assembly 100 configured to receive exhaust gas 88 via the exhaust gas duct 28 (see, e.g., FIGS. 12 and 13) of the GTE 24, electrical power from the electric power generation device 46, and liquid from the one or more liquid source(s) 42. The methanol conversion assembly 100 may be configured to convert at least a portion of the exhaust gas 88, a portion of the electrical power, and a portion of the liquid into methanol 102. In some embodiments, the methanol conversion assembly 100 may include a water electrolysis reactor 104 configured to split water into oxygen 106 and hydrogen 108. The methanol conversion assembly 100 also may include a methanol generation reactor 110 configured to cause carbon dioxide 112 in the at least a portion of the exhaust gas 88 to react with the hydrogen 108 to form methanol 102. Some embodiments further may include a conduit 116 providing fluid flow between the methanol conversion assembly 100 and a fuel supply 54 used to supply the GTE 24 or the GTE 24 (e.g., directly) to be used as fuel. In some embodiments, the fuel supply 54 may include one or more of natural gas, diesel fuel, gasoline, or other combustible fuel source. In some embodiments, at least a portion of one or more of the oxygen 106, the hydrogen 108, and/or the methanol 102 may be supplied to the fuel supply 54 and/or the GTE 24 to be used as fuel or as a supplement to fuel. For example, as shown in FIG. 20, at least a portion of the hydrogen 108 may be supplied to the fuel supply 54 and/or the GTE 24 via the conduit 116. Some embodiments may include a conduit providing fluid flow between the methanol conversion assembly 100 and one or more of a fuel supply 54 to supply an internal combustion engine or the internal combustion engine (e.g., directly) for at least a portion of one or more of the hydrogen 108 and/or the methanol 102 to be used as fuel. In some embodiments, the internal combustion engine may be used to supply power for the operation of auxiliary devices associated with the hydraulic fracturing unit 138. In some embodiments, hydrogen may be obtained from at least a portion of the methanol 102, for example, via a methanol cracking process, and at least a portion of the hydrogen obtained from the methanol may be supplied to the GTE 24 as fuel and/or as a fuel supplement, for example, to be combined with natural gas and used as fuel for the GTE 24.

In some embodiments consistent with FIG. 20, one or more of the GTEs 24 may be used to mechanically drive respective hydraulic fracturing pumps 140. Heat from the exhaust gas 88 may be recovered via the heat exchanger(s) 38 to provide steam (see, e.g., steam 90 in FIGS. 12 and 13) to drive the steam turbine 44 to generate electric power. The generated electric power may be used to split water into hydrogen 108 and oxygen 106, for example, via electrolysis (e.g., using the water electrolysis reactor 104). The hydrogen 108 may be reacted with carbon dioxide 112 from the exhaust gas 88 to produce liquid methanol 102, which may serve as a chemical energy storage medium, which may result in reducing greenhouse gas emission toward essentially zero. Alternatively, or in addition, the hydrogen 108 may be blended with natural gas as a fuel source for the GTEs 24 20. In some embodiments, liquid source(s) 42 (e.g., water sources) for steam generation may include, but are not limited to, flowback water, produced water, geothermal water, wastewater, and/or any other water of liquid readily available at the wellsite operation 22.

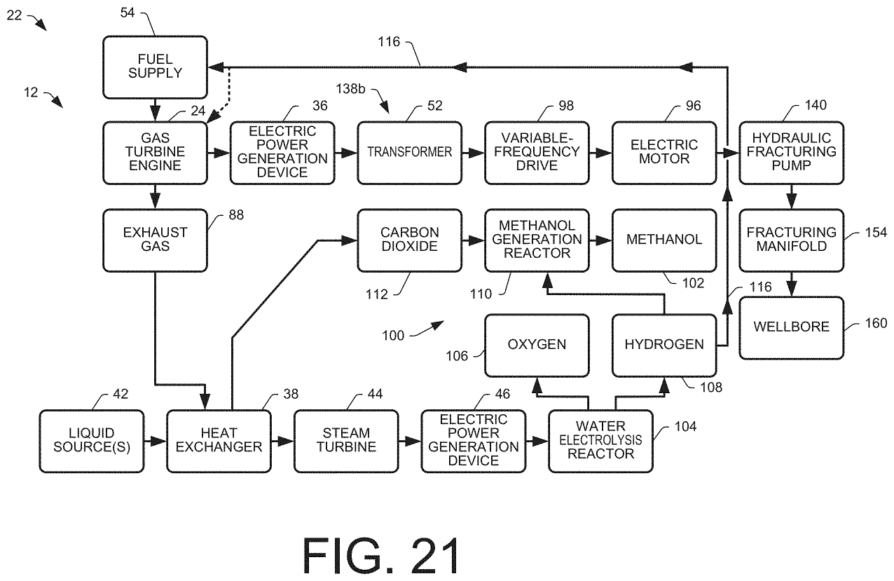

FIG. 21 is a block diagram of an example power generation assembly 12 for an example wellsite operation 22 including an example electrically-driven hydraulic fracturing unit 138b and example methanol conversion assembly 100 according to some embodiments of the disclosure. The embodiment shown in FIG. 21 is similar to the embodiment shown in FIG. 20, except that in the embodiment shown in FIG. 21, the hydraulic fracturing unit 138b is electrically-driven instead of mechanically-driven. In some embodiments, the mechanically-driven hydraulic fracturing units 138a and the electrically-driven fracturing units 138b may be combined in a single hydraulic fracturing system 136.

In some embodiments consistent with FIG. 21, one or more of the GTEs 24 may be used to generate electricity to drive respective hydraulic fracturing pumps 140 via electric motors 96. Heat from the exhaust gas 88 may be recovered via the heat exchanger(s) 38 to provide steam (see, e.g., steam 90 in FIGS. 12 and 13) to drive the steam turbine 44 to generate electric power. The generated electric power may be used to split water into hydrogen 108 and oxygen 106, for example, via electrolysis. The hydrogen 108 may be reacted with carbon dioxide 112 from the exhaust gas 88 to produce liquid methanol 102, which may serve as a chemical energy storage medium, which may result reducing greenhouse gas emission toward essentially zero. Alternatively, or in addition, the hydrogen 108 may be blended with natural gas as a fuel source for the GTEs 24. In some embodiments, liquid source(s) 42 (e.g., water sources) for steam generation may include, but are not limited to, flowback water, produced water, geothermal water, wastewater, and/or any other water or liquid readily available at the wellsite operation 22.

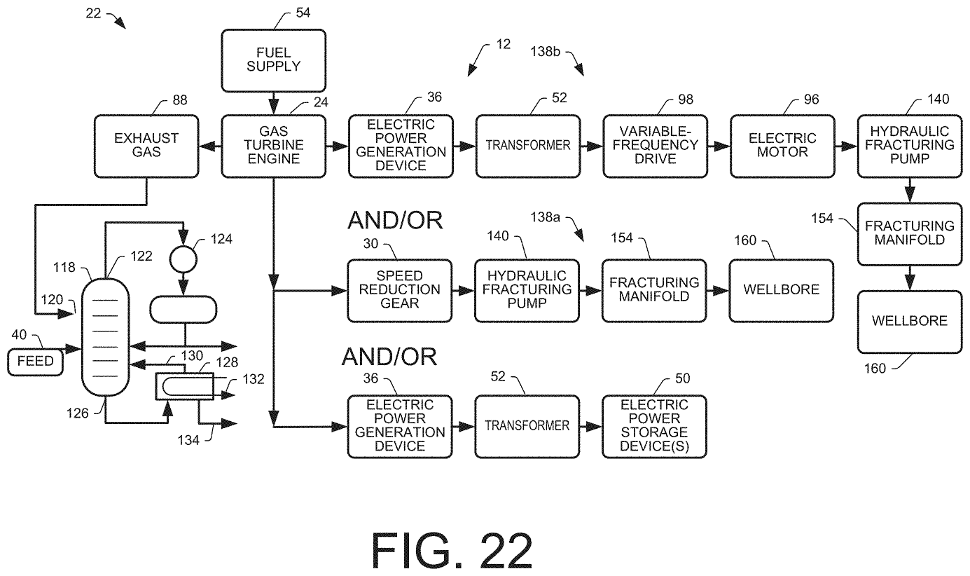

FIG. 22 is a block diagram of an example power generation assembly 12 for an example wellsite operation 22, including an example mechanically-driven hydraulic fracturing unit 138a, an example electrically-driven hydraulic fracturing unit 138b, and/or one or more example power storage devices(s) 50, combined with an example distillation column 118 supplied with heat from the exhaust gas 88 of a GTE 24 according to some embodiments of the disclosure. The power generation assembly 12 may include a distillation column 118 positioned to receive the exhaust gas 88 during operation of the GTE 24. The distillation column 118 may include an exhaust gas inlet 120 positioned to receive exhaust gas 88 from the exhaust gas duct 28 (see, e.g., FIGS. 12 and 13). The distillation column 118 may also include a liquid inlet positioned to receive liquid 40 from one or more liquid source(s) 42. The distillation column 118 may be positioned to convert liquid into steam via heat from the exhaust gas 88. The distillation column 118 also may include a steam outlet 122 positioned at an upper portion of the distillation column 118 to release steam. As shown in FIG. 22, the power generation assembly 12 may also include a condenser 124 positioned to receive fluid flow from the steam outlet 122 and to condense steam to provide a distilled liquid for use in wellsite operations. The distilled liquid may be water. In some embodiments, at least a portion of the distilled liquid may be injected into the distillation column 118.

In some embodiments consistent with FIG. 22, the distillation column 118 may be a multi-tray distillation column including an outer shell. The distillation column 118 may include a feed stream inlet connected to and in fluid communication with the exhaust outlet to receive a heated exhaust gas 88 therefrom, a water inlet connected to and positioned proximate a bottom portion of the outer shell to receive a process water from the wellsite, and one or more distillate side streams connected to and positioned proximate a top portion of the outer shell to remove steam therefrom. The distillation column 118 may be arranged to transfer heat from the heated exhaust gas 88 to the process liquid (e.g., water) to thereby generate the steam.

In some embodiments, a bottoms stream 126 may be connected to and positioned proximate the bottom portion of the outer shell to receive a bottoms liquid product. In some embodiments, a reboiler 128 may be connected to and in fluid communication with the bottoms stream 126. For example, the reboiler 128 may be positioned to vaporize at least a portion of the bottoms liquid product in the bottoms stream 126 to produce a vapor 130 that may be reinjected onto a lower tray of the distillation column 118. A reboiler recovery stream 132 may be connected to and in fluid communication with the reboiler 128, and the reboiler recovery stream 132 may be positioned to receive a non-vaporized portion 134 of the bottoms liquid product to be used for other wellsite operations. For example, the non-vaporized portion 134 of the bottoms liquid product may be used as heavy brine for hydraulic fracturing operations.

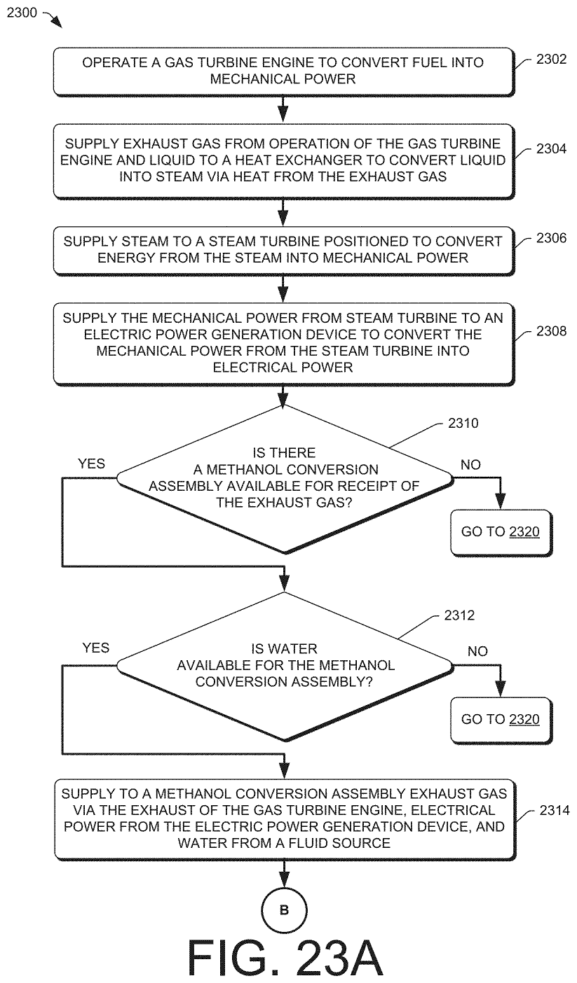

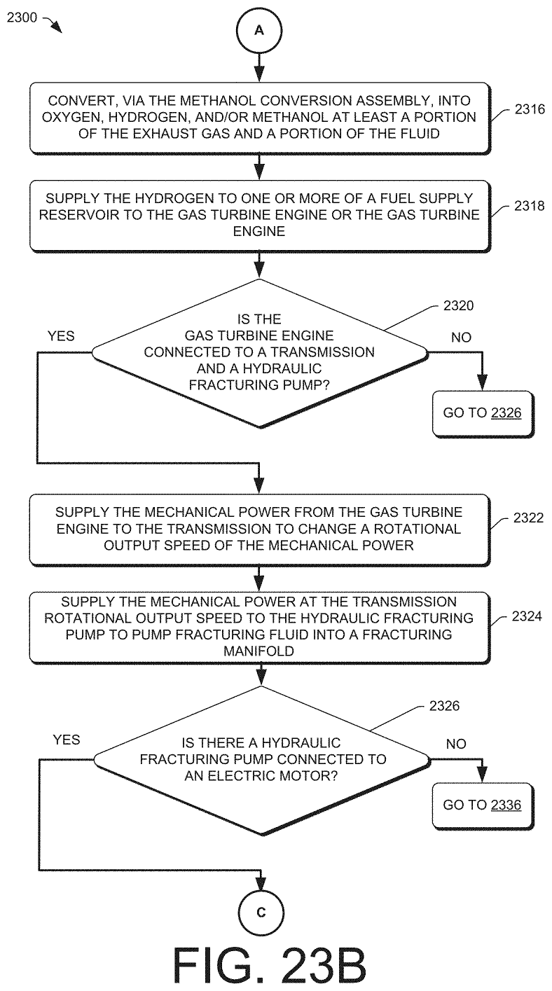

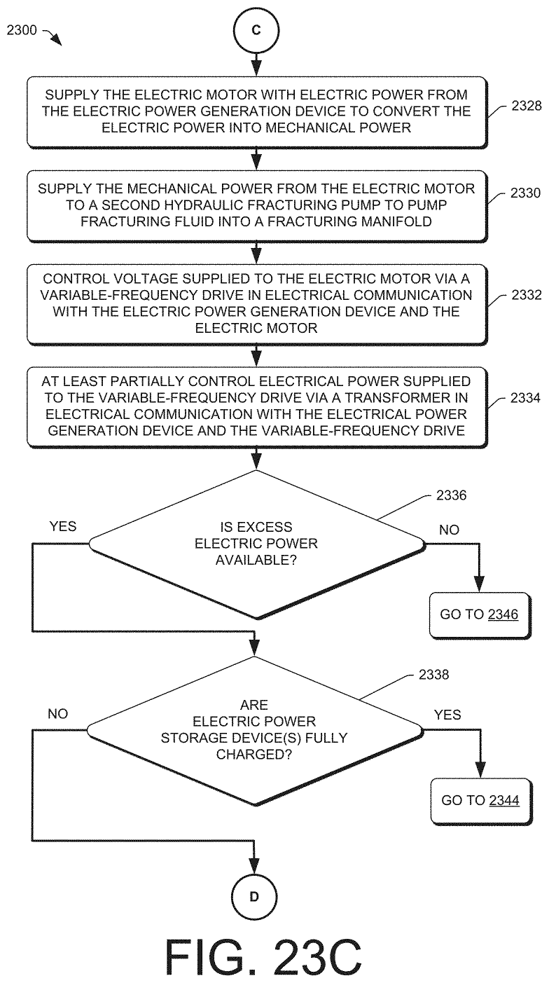

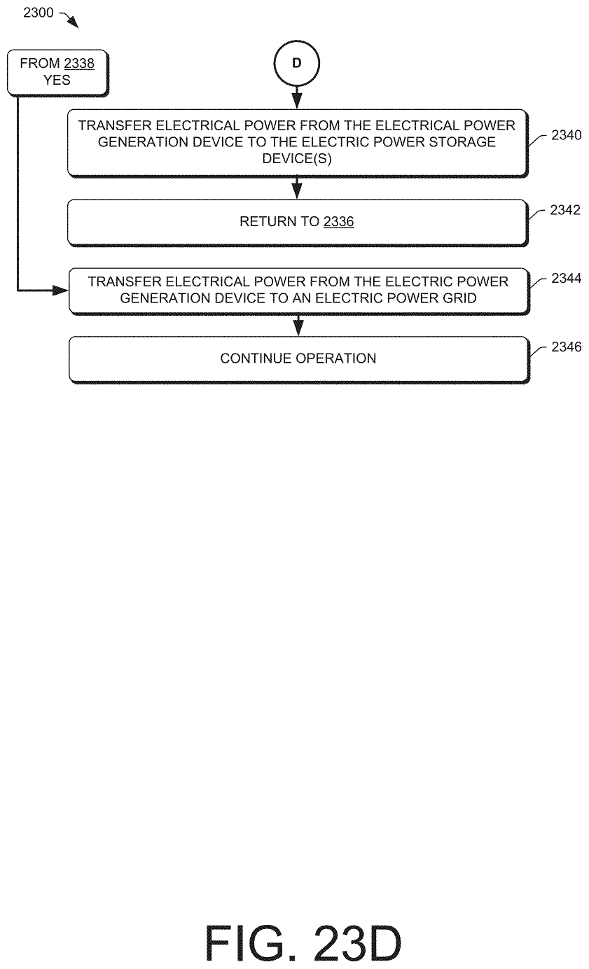

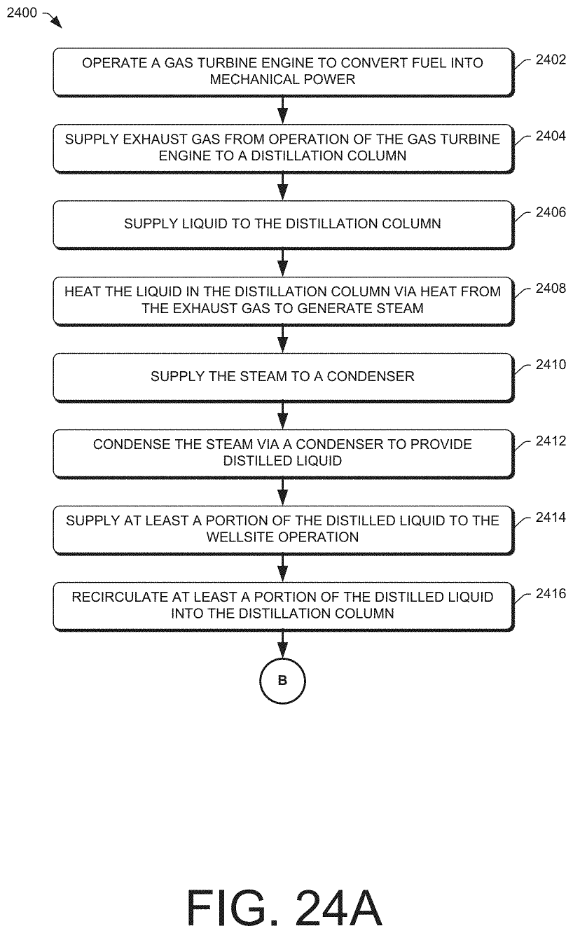

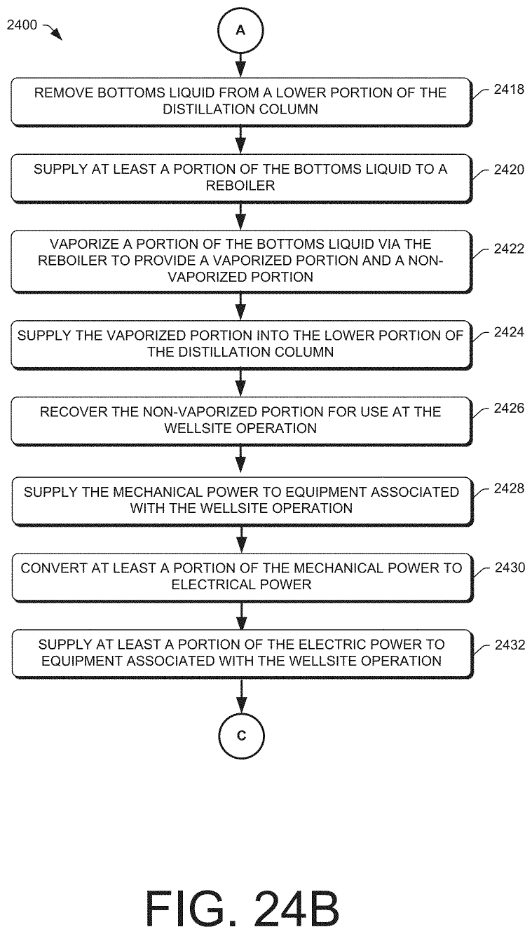

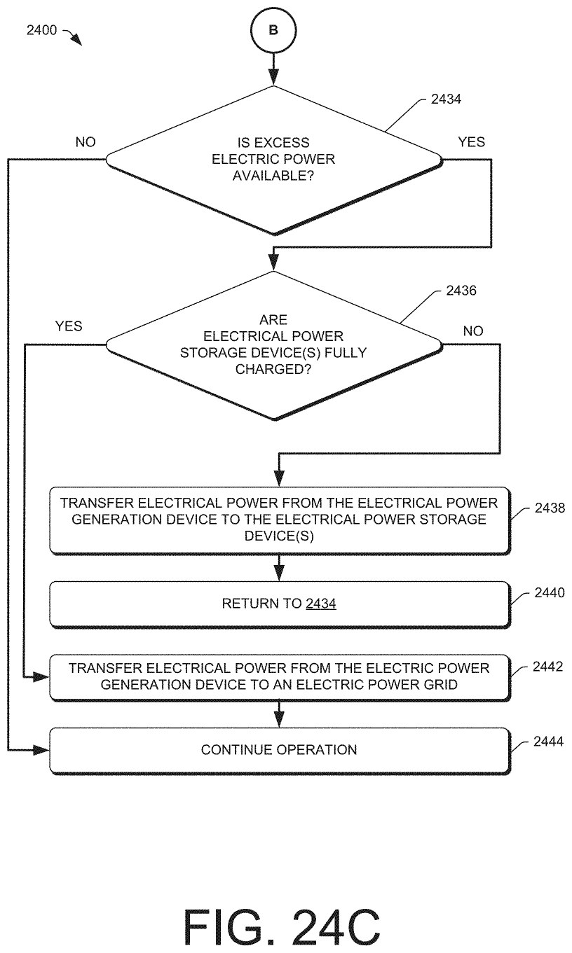

FIG. 23A, FIG. 23B, FIG. 23C, FIG. 23D, FIG. 24A, FIG. 24B, and FIG. 24C show block diagrams of example methods 2300 and 2400, respectively, according to embodiments of the disclosure, illustrated as respective collections of blocks in logical flow graphs, which represent a sequence of operations. FIGS. 23A, 23B, 23C, and 23D are a block diagram of an example method 2300 to enhance power efficiency and/or reduce greenhouse gas emissions associated with a wellsite operation. FIGS. 24A, 24B, and 24C are a block diagram of an example method 2400 to generate power and supply distilled liquid to enhance a wellsite operation, according to embodiments of the disclosure. For each of the respective example methods, the order in which the operations are described is not intended to be construed as a limitation, and any number of the described blocks may be combined in any order and/or in parallel to implement the method.

FIGS. 23A, 23B, 23C, and 23D are a block diagram of an example method 2300 to enhance power efficiency and/or reduce greenhouse gas emissions associated with a wellsite operation. As shown in FIG. 23A, the example method 2300, at 2302, may include operating a gas turbine engine to convert fuel into mechanical power, for example, as described herein.

The example method 2300, at 2304, may include supplying exhaust gas from operation of the gas turbine engine and liquid to a heat exchanger to convert liquid into steam via heat from the exhaust gas, for example, as described herein.

At 2306, the example method 2300 may include supplying steam to a steam turbine positioned to convert energy from the steam into mechanical power, for example, as described herein.

The example method 2300, at 2308, may include supplying the mechanical power from steam turbine to an electric power generation device to convert the mechanical power from the steam turbine into electrical power, for example, as described herein.

At 2310, the example method 2300 may include determining whether there is a methanol conversion assembly available for receipt of the exhaust gas. If not, the example method 2300 may include skipping to 2320 (FIG. 23B).

If at 2310, there is a methanol conversion assembly available, the example method 2300, at 2312, may include determining whether there is water available for the methanol conversion assembly. If not, the example method 2300 may include skipping to 2320 (FIG. 23B).

If at 2312, there is a water available, the example method 2300, at 2314, may include supplying to the methanol conversion assembly exhaust gas via the exhaust of the gas turbine engine, electrical power from the electric power generation device, and water from a fluid source, for example, as described herein.

The example method 2300, at 2316 (FIG. 23B), may include converting, via the electrolysis or methanol conversion assembly, into oxygen, hydrogen, and/or methanol at least a portion of the exhaust gas and a portion of the fluid, for example, as described herein.

At 2318, the example method 2300 may include supplying hydrogen, and/or methanol to one or more of a fuel supply reservoir to the gas turbine engine or to the gas turbine engine, for example, as described herein.

The example method 2300, at 2320, may include determining whether the gas turbine engine is connected to a speed reduction gear and a hydraulic fracturing pump. If not, the example method may include skipping to 2326.

If at 2320, it is determined that the gas turbine engine is connected to a speed reduction gear and a hydraulic fracturing pump, at 2322, the example method may include supplying the mechanical power from the gas turbine engine to the speed reduction gear to change a rotational output speed of the mechanical power.

The example method 2300, at 2324, may include supplying the mechanical power at the speed reduction gear rotational output speed to the hydraulic fracturing pump to pump fracturing fluid into a fracturing manifold.

At 2326, the example method 2300 may include determining whether a hydraulic fracturing pump is connected to an electric motor. If not, the example method 2300 may include skipping to 2336 (FIG. 23C).

If at 2326 it is determined that a hydraulic fracturing pump is connected to an electric motor, at 2328 (FIG. 23C), the example method may include supplying the electric motor with electric power from the electric power generation device to convert the electric power into mechanical power, for example, as described herein.

At 2330, the example method 2300 may include supplying the mechanical power from the electric motor to a second hydraulic fracturing pump to pump fracturing fluid into a fracturing manifold.

The example method 2300, at 2332, may include controlling voltage supplied to the electric motor via a variable-frequency drive in electrical communication with the electric power generation device and the electric motor.

At 2334, the example method 2300 may include at least partially controlling electrical power supplied to the variable-frequency drive via a transformer in electrical communication with the electrical power generation device and the variable-frequency drive.

The example method 2300, at 2336, may include determining whether there is excess electric power. If not, the example method may include skipping to 2346 (FIG. 23D).

If at 2336 it is determined that there is excess electric power, at 2338, the example method 2300 may include determining whether the electric power storage device(s) are fully charged. If so, the example method 2300 may include skipping to 2344 (FIG. 23D).

If at 2336 it is determined the electric power storage device(s) are not fully charged, at 2340 (FIG. 23D), the example method 2300 may include transferring electrical power from the electrical power generation device(s) to the electric power storage device(s).

At 2342, the example method 2300 may include returning to 2336 to determine whether there is excess electric power.

The example method 2300, at 2344, may include transferring electrical power from the electric power generation device to an electric power grid.

At 2346, the example method 2300 may include continuing operation, which may include returning to 2302 (FIG. 23A).

FIGS. 24A, 24B, and 24C are a block diagram of an example method 2400 to generate power and supply distilled liquid to enhance a wellsite operation, according to embodiments of the disclosure. At 2402, the example method 2400 may include operating a gas turbine engine to convert fuel into mechanical power.

At 2404, the example method 2400 may include supplying exhaust gas from operation of the gas turbine engine to a distillation column.

The example method 2400, at 2406, may include supplying liquid to the distillation column.

At 2408, the example method 2400 may include heating the liquid in the distillation column via heat from the exhaust gas to generate steam.

The example method 2400, at 2410, may include supplying the steam to a condenser.

At 2412, the example method 2400 may include condensing the steam via the condenser to provide distilled liquid.

The example method 2400, at 2414, may include supplying at least a portion of the distilled liquid to the wellsite operation.

At 2416, the example method 2400 may include recirculating at least a portion of the distilled liquid into the distillation column.

The example method 2400, at 2418 (FIG. 24B), may include removing bottoms liquid from a lower portion of the distillation column.

At 2420, the example method 2400 may include supplying at least a portion of the bottoms liquid to a reboiler.

The example method 2400, at 2422, may include vaporizing a portion of the bottoms liquid via the reboiler to provide a vaporized portion and a non-vaporized portion.

At 2424, the example method 2400 may include supplying the vaporized portion into the lower portion of the distillation column.

The example method 2400, at 2426, may include recovering the non-vaporized portion for use at the wellsite operation.

At 2428, the example method 2400 may include supplying the mechanical power to equipment associated with the wellsite operation.

The example method 2400, at 2430, may include converting at least a portion of the mechanical power to electrical power.

At 2432, the example method 2400 may include supplying at least a portion of the electric power to equipment associated with the wellsite operation.

The example method 2400, at 2434 (FIG. 24C), may include determining whether there is excess electric power available. If not, the example method 2400 may include skipping to 2444 and continuing operation, which may include returning to 2402.

If, at 2434, it is determined that excess electric power is available, at 2436, the example method 2400 may include determining whether electrical power storage device(s) are fully charged. If so, the example method may include skipping to 2442.

If, at 2436, it is determined that the electric power storage device(s) are not fully charged, at 2438, the example method 2400 may include transferring electrical power from the electrical power generation device to the electrical power storage device(s).

At 2440, the example method 2400 may include returning to 2434 to determine whether excess electric power is available.

The example method 2400, at 2442, may include transferring electrical power from the electric power generation device to an electric power grid.

At 2444, the example method 2400 may include continuing operation, which may include returning to 2402 (FIG. 24A).

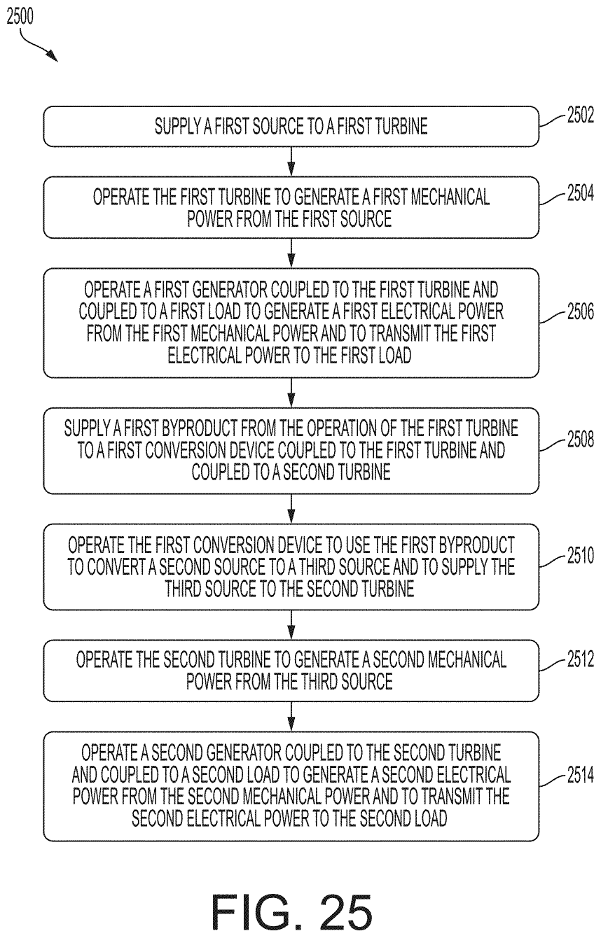

FIG. 25 is a block diagram of an example method 2500 to enhance power efficiency and/or reduce greenhouse gas emissions according to some embodiments of the disclosure.

As shown in FIG. 25, at 2502, the example method 2500 may include supplying a first source to a first turbine.

At 2504, the example method 2500 may include operating the first turbine to generate a first mechanical power from the first source.

At 2506, the example method 2500 may include operating a first generator coupled to the first turbine and coupled to a first load to generate a first electrical power from the first mechanical power and to transmit the first electrical power to the first load.

At 2508, the example method 2500 may include supplying a first byproduct from the operation of the first turbine to a first conversion device coupled to the first turbine and coupled to a second turbine.

At 2510, the example method 2500 may include operating the first conversion device to use the first byproduct to convert a second source to a third source and to supply the third source to the second turbine.

At 2512, the example method 2500 may include operating the second turbine to generate a second mechanical power from the third source.

At 2514, the example method 2500 may include operating a second generator coupled to the second turbine and coupled to a second load to generate a second electrical power from the second mechanical power and to transmit the second electrical power to the second load.

The example method 2500 may include connecting to one or more of a mobile chassis at least one of the first turbine, the first generator, the first conversion device, the second turbine, or the second generator.

The example method 2500 may include transporting at least one of the one or more mobile chassis to a location associated with at least one of the first load or the second load.

According to a first aspect of the disclosure, a power generation assembly to one or more of enhance power efficiency or reduce greenhouse gas emissions, includes a gas turbine engine positioned to convert fuel into mechanical power, the gas turbine engine comprising a gas turbine output shaft and an exhaust gas duct positioned to receive exhaust gas during operation of the gas turbine engine; a speed reduction gear comprising a transmission input shaft connected to the gas turbine output shaft, a transmission output shaft, and a gear assembly positioned to cause the transmission output shaft to rotate at a different rotational speed than a rotational speed of the transmission input shaft; a first electric power generation device comprising a generator input shaft connected to the transmission output shaft and positioned to convert mechanical power supplied by the gas turbine engine into electrical power; a heat exchanger positioned to receive the exhaust gas during operation of the gas turbine engine, the heat exchanger comprising an exhaust gas inlet positioned to receive exhaust gas from the exhaust gas duct and a liquid inlet positioned to receive liquid from a liquid source, the heat exchanger being positioned to convert liquid into steam via heat from the exhaust; a steam turbine positioned to receive steam from the heat exchanger and to convert energy from the steam into mechanical power; a second electric power generation device connected to the steam turbine and positioned to convert the mechanical power from the steam turbine into electrical power; and/or one or more of the first electric power generation device or the second electric power generation device being positioned to supply electric power to one or more of one or more power-dependent operations or one or more power storage devices.

According to a second aspect of the disclosure, in combination with the first aspect, the one or more power-dependent operations comprise one or more of an electric power grid, a solar farm, a wind farm, a wellsite operation, a mining site operation, a wastewater treatment operation, a natural gas production operation, or a cryptocurrency operation; or the one or more power storage devices comprise an electric power storage device, a chemical power storage device, or a mechanical power storage device.

According to a third aspect of the disclosure, in combination with one or more of the first aspect through the second aspect, the power generation assembly may also include a mechanical device configured to be operated via an input torque and comprising a mechanical device input shaft; and an electric motor in electrical communication with one or more of the first electric power generation device or the second electrical power generation device, the electric motor comprising a motor output shaft connected to the mechanical device input shaft.

According to a fourth aspect of the disclosure, in combination with one or more of the first aspect through the third aspect, the power generation assembly may also include a variable-frequency drive in electrical communication with the electric motor and the one or more of the first electric power generation device or the second electric power generation device, the variable-frequency drive being configured to control voltage supplied to the electric motor.

According to a fifth aspect of the disclosure, in combination with one or more of the first aspect through the fourth aspect, the power generation assembly may also include a transformer in electrical communication with the variable-frequency drive and the one or more of the first electric power generation device or the second electric power generation device, the transformer being configured to at least partially control electrical power supplied to the variable-frequency drive.

According to a sixth aspect of the disclosure, in combination with one or more of the first aspect through the fifth aspect, the power generation assembly may also include one or more of an electric power storage device or a capacitor in electrical communication with one or more of the first electric power generation device or the second electric power generation device.

According to a seventh aspect of the disclosure, in combination with one or more of the first aspect through the sixth aspect, the power generation assembly may also include a transformer in electrical communication with the one or more of the first electric power generation device or the second electric power generation device and the one or more of the electric power storage device or the capacitor, the transformer being positioned to transfer electrical power from the one or more of the first electric power generation device or the second electric power generation device to the one or more of the electric power storage device or the capacitor.

According to an eighth aspect of the disclosure, in combination with one or more of the first aspect through the seventh aspect, the power generation assembly may also include a methanol conversion assembly positioned to: receive exhaust gas via the exhaust gas duct of the gas turbine engine, electrical power from one or more of the first electric power generation device or the second electric power generation device, and fluid from a fluid source; and convert at least a portion of the exhaust gas, at least a portion of the electrical power, and at least a portion of the fluid into one or more of oxygen, hydrogen, or methanol.

According to a ninth aspect of the disclosure, in combination with one or more of the first aspect through the eighth aspect, the methanol conversion assembly comprises: a water electrolysis reactor configured to split water into oxygen and hydrogen; and a methanol generation reactor configured to cause carbon dioxide in the at least a portion of the exhaust gas to react with the oxygen and hydrogen to form methanol.

According to a tenth aspect of the disclosure, in combination with one or more of the first aspect through the ninth aspect, the power generation assembly may also include a conduit providing fluid flow between the methanol conversion assembly and one or more of a fuel supply to supply the gas turbine engine or the gas turbine engine to be used as fuel.

According to an eleventh aspect of the disclosure, in combination with one or more of the first aspect through the tenth aspect, the fuel supply comprises one or more of natural gas, diesel fuel, gasoline, or other combustible fuel source.

According to a twelfth aspect of the disclosure, in combination with one or more of the first aspect through the eleventh aspect, the power generation assembly may also include a conduit providing fluid flow between the water electrolysis reactor and one or more of a fuel supply to supply the gas turbine engine or the gas turbine engine with one or more of oxygen or hydrogen to be used as fuel.

According to a thirteenth aspect of the disclosure, in combination with one or more of the first aspect through the twelfth aspect, the power generation assembly may also include a conduit providing fluid flow between the methanol conversion assembly and one or more of a fuel supply to supply an internal combustion engine or the internal combustion engine with one or more of oxygen, hydrogen, or methanol to be used as fuel.

According to a fourteenth aspect of the disclosure, in combination with one or more of the first aspect through the thirteenth aspect, the power generation assembly may also include an injection well conduit positioned to provide a flow path between the exhaust gas duct and an injection well.

According to a fifteenth aspect of the disclosure, in combination with one or more of the first aspect through the fourteenth aspect, the power generation assembly may also include a water supply conduit to provide fluid flow to the liquid inlet of the heat exchanger from one or more of: a flowback water source; a product water source; a geothermal water source; or a wastewater source.

According to a sixteenth aspect of the disclosure, in combination with one or more of the first aspect through the fifteenth aspect, the heat exchanger comprises a heat recovery steam generator positioned to receive the exhaust gas during operation of the gas turbine engine, the heat recovery steam generator comprising the exhaust gas inlet positioned to receive exhaust gas from the exhaust gas duct and the liquid inlet positioned to receive liquid from a liquid source.

According to a seventeenth aspect of the disclosure, in combination with one or more of the first aspect through the sixteenth aspect, the heat exchanger comprises a distillation column; the exhaust gas inlet is connected to the distillation column and is positioned to receive exhaust gas from the exhaust gas duct of the gas turbine engine; the liquid inlet is located at a lower portion of the distillation column and positioned to receive liquid from the liquid source; and the distillation column comprises a steam outlet positioned at an upper portion of the distillation column to release steam.

According to an eighteenth aspect of the disclosure, in combination with one or more of the first aspect through the seventeenth aspect, the power generation assembly may also include a condenser positioned to receive fluid flow from the steam outlet and to condense steam to provide a distilled liquid for use with the one or more power-dependent operations.

According to an nineteenth aspect of the disclosure, in combination with one or more of the first aspect through the eighteenth aspect, the power generation assembly may also include a bottoms outlet connected to a lower portion of the distillation column and positioned to receive a bottoms liquid; a reboiler connected to the bottoms outlet and a lower portion of the distillation column, the reboiler being positioned to vaporize at least a portion of the bottoms liquid to produce vapor, such that the vapor is injected into the lower portion of the distillation column; and a reboiler recovery outlet connected to the reboiler and positioned to receive a non-vaporized portion of the bottoms liquid for use with the one or more power-dependent operations.

According to a twentieth aspect of the disclosure, in combination with one or more of the first aspect through the nineteenth aspect, the power generation assembly may also include a liquid injection inlet connected to the distillation column and positioned to provide at least a portion of the distilled liquid from the condenser to the distillation column.

According to a twenty-first aspect of the disclosure, in combination with one or more of the first aspect through the twentieth aspect, one or more of the first electric power generation device or the second electric power generation device are in electrical communication with one or more of equipment associated with a wellsite operation.

According to a twenty-second aspect of the disclosure, in combination with one or more of the first aspect through the twentieth-first aspect, the power generation assembly may also include a mobile chassis, wherein one or more of the gas turbine engine, the speed reduction gear, the first electric power generation device, the heat exchanger, the steam turbine, or the second power electric power generation device are connected to the mobile chassis.

According to a twenty-third aspect of the disclosure, in combination with one or more of the first aspect through the twentieth-second aspect, the power generation assembly may also include the mobile chassis comprises a first mobile chassis and the power generation assembly further comprises a second mobile chassis; one or more of the gas turbine engine, the speed reduction gear, or the first electric power generation device are connected to the first mobile chassis; and one or more of the heat exchanger, the steam turbine, or the second power electric power generation device are connected to the mobile chassis.

According to a twenty-fourth aspect of the disclosure, in combination with one or more of the first aspect through the twentieth-third aspect, each of the plurality of power generation assemblies being electrically connectable to supply electric power to one or more electrically-powered devices associated with the one or more power-dependent operations. According to a twenty-fifth aspect of the disclosure, in combination with one or more of the first aspect through the twentieth-fourth aspect, a method to one or more of enhance power efficiency or reduce greenhouse gas emissions may include operating a gas turbine engine to convert fuel into mechanical power; supplying the mechanical power from the gas turbine engine to a speed reduction gear to change a rotational output speed of the mechanical power supplied by the gas turbine engine to a transmission rotational output speed; supplying the mechanical power at the speed reduction gear rotational output speed to a first electric power generation device to convert the mechanical power from the gas turbine engine into electrical power; supplying exhaust gas from operation of the gas turbine engine and liquid to a heat exchanger to convert liquid into steam via heat from the exhaust gas; supplying steam to a steam turbine positioned to convert energy from the steam into mechanical power; supplying the mechanical power from the steam turbine to a second electric power generation device to convert the mechanical power from the steam turbine into electrical power; and supplying electric power from one or more of the first electric power generation device or the second electric power generation device to one or more of one of more power-dependent operations or one or more power storage devices.

According to a twenty-sixth aspect of the disclosure, in combination with the twenty-fifth aspect, supplying electric power from one or more of the first electric power generation device or the second electric power generation device to one or more of one of more power-dependent operations or one or more power storage devices comprises one or more of: supplying electric power to one or more of an electric power grid, a solar farm, a wind farm, a wellsite operation, a mining site operation, a wastewater treatment operation, a natural gas production operation, or a cryptocurrency operation; or supplying electric power to one or more of one or more electric power storages devices, one or more chemical power storage devices, or one or more mechanical power storage devices.

According to a twenty-seventh aspect of the disclosure, in combination with one or more of the twenty-fifth aspect through the twenty-sixth aspect, the method also includes supplying an electric motor with electric power from one or more of the first electric power generation device or the second electric power generation device; and suppling the mechanical power from the electric motor to a mechanical device configured to be operated via an input torque.

According to a twenty-eighth aspect of the disclosure, in combination with one or more of the twenty-fifth aspect through the twenty-seventh aspect, the method also includes controlling voltage supplied to the electric motor via a variable-frequency drive in electrical communication with the electric motor and the one or more of the first electric power generation device or the second electric power generation device.

According to a twenty-ninth aspect of the disclosure, in combination with one or more of the twenty-fifth aspect through the twenty-eighth aspect, the method also includes at least partially controlling electrical power supplied to the variable-frequency drive via a transformer in electrical communication with the variable-frequency drive and the one or more of the first electric power generation device or the second electric power generation device.

According to a thirtieth aspect of the disclosure, in combination with one or more of the twenty-fifth aspect through the twenty-ninth aspect, the method also includes supplying electrical power to one or more of an electric power storage device or a capacitor in electrical communication with one or more of the first electric power generation device or the second electric power generation device.

According to a thirty-first aspect of the disclosure, in combination with one or more of the twenty-fifth aspect through the thirtieth aspect, the method also includes transferring electrical power from the one or more of the first electric power generation device or the second electric power generation device to the one or more of the electric power storage device or the capacitor via a transformer in electrical communication with the one or more of the first electric power generation device or the second electric power generation device and the one or more of the electric power storage device or the capacitor.

According to a thirty-second aspect of the disclosure, in combination with one or more of the twenty-fifth aspect through the thirty-first aspect, the method also includes supplying to a methanol conversion assembly exhaust gas via the exhaust gas duct of the gas turbine engine, electrical power from one or more of the first electric power generation device or the second electric power generation device, and fluid from a fluid source; and converting, via the methanol conversion assembly, into one or more of oxygen, hydrogen, or methanol at least a portion of the exhaust gas and a portion of the fluid.

According to a thirty-third aspect of the disclosure, in combination with one or more of the twenty-fifth aspect through the thirty-second aspect, converting into one or more of oxygen, hydrogen or, methanol the at least a portion of the exhaust gas, the portion of the electrical power, and the portion of the fluid comprises: splitting water into oxygen and hydrogen; and causing carbon dioxide in the at least a portion of the exhaust gas to react with the oxygen and hydrogen to form methanol.

According to a thirty-fourth aspect of the disclosure, in combination with one or more of the twenty-fifth aspect through the thirty-third aspect, the method also includes supplying one or more of the oxygen, the hydrogen, or the methanol to one or more of a fuel supply to the gas turbine engine or the gas turbine engine.

According to a thirty-fifth aspect of the disclosure, in combination with one or more of the twenty-fifth aspect through the thirty-fourth aspect, the method also includes supplying one of more of natural gas, diesel fuel, gasoline, or other combustible fuel source to the gas turbine engine.

According to a thirty-sixth aspect of the disclosure, in combination with one or more of the twenty-fifth aspect through the thirty-fifth aspect, the method also includes supplying the hydrogen to one or more of a fuel supply to supply the gas turbine engine or the gas turbine engine to be used as fuel.

According to a thirty-seventh aspect of the disclosure, in combination with one or more of the twenty-fifth aspect through the thirty-sixth aspect, the method also includes supplying one or more of the oxygen, the hydrogen, or the methanol to one or more of a fuel supply to supply an internal combustion engine or the internal combustion engine to be used as fuel.

According to a thirty-eighth aspect of the disclosure, in combination with one or more of the twenty-fifth aspect through the thirty-seventh aspect, the method also includes supplying at least a portion of the exhaust gas from the gas turbine engine to an injection well.

According to a thirty-ninth aspect of the disclosure, in combination with one or more of the twenty-fifth aspect through the thirty-eighth aspect, the method also includes supplying to the heat exchanger liquid from one or more of: a flowback water source; a product water source; a geothermal water source; or a wastewater source.

According to a fortieth aspect of the disclosure, in combination with one or more of the twenty-fifth aspect through the thirty-ninth aspect, the method also includes supplying exhaust gas from operation of the gas turbine engine to a distillation column; supplying liquid to the distillation column; heating the liquid in the distillation column via heat from the exhaust gas to generate steam; supplying the steam to a condenser; condensing the steam via the condenser to provide distilled liquid; and supplying the distilled liquid to one or more of the power-dependent operations.

According to a forty-first aspect of the disclosure, in combination with one or more of the twenty-fifth aspect through the fortieth aspect, condensing the steam via a condenser to provide distilled liquid comprises providing distilled water.

According to a forty-second aspect of the disclosure, in combination with one or more of the twenty-fifth aspect through the forty-first aspect, the method includes recirculating at least a portion of the distilled liquid into the distillation column.

According to a forty-third aspect of the disclosure, in combination with one or more of the twenty-fifth aspect through the forty-second aspect, the method includes supplying the mechanical power to equipment associated with the one or more of the power-dependent operations.

According to a forty-forth aspect of the disclosure, in combination with one or more of the twenty-fifth aspect through the forty-third aspect, the method includes converting at least a portion of the mechanical power to electric power; and one or more of: supplying at least a portion of the electric power to equipment associated with the one or more of the power-dependent operations; supplying at least a portion of the electric power to the one or more power-dependent operations; or storing at least a portion of the electrical power in at least one of an electric power storage device or a capacitor.

According to a forty-fifth aspect of the disclosure, in combination with one or more of the twenty-fifth aspect through the forty-fourth aspect, supplying liquid to the distillation column comprises supplying to the distillation column one or more of flowback water, produced water, geothermal water, wastewater, or water associated with the one or more power-dependent operations.

According to a forty-sixth aspect of the disclosure, in combination with one or more of the twenty-fifth aspect through the forty-fifth aspect, the method includes removing bottoms liquid from a lower portion of the distillation column; supplying at least a portion of the bottoms liquid to a reboiler; vaporizing a portion of the bottoms liquid via the reboiler to provide a vaporized portion and a non-vaporized portion; supplying the vaporized portion into the lower portion of the distillation column; and recovering the non-vaporized portion for use at the one or more power-dependent operations.

According to a forty-seventh aspect of the disclosure, in combination with one or more of the twenty-fifth aspect through the forty-sixth aspect, the method includes supplying the non-vaporized portion to a high-pressure hydraulic fracturing operation for use as heavy brine.

According to a forty-eighth aspect of the disclosure, in combination with one or more of the first aspect through the forty-seventh aspect, a method of supplying power to one or more of one or more power-dependent operations or one or more power storage devices may include moving a plurality of power generation assemblies to a geographic location associated with the one or more of the power-dependent operations or the one or more power storage devices; and supplying power to the one or more of the one or more power-dependent operations or the one or more power storage devices.

According to a forty-ninth aspect of the disclosure, in combination with the forty-eighth aspect, moving a plurality of power generation assemblies to a geographic location comprises: connecting the plurality of power generation assemblies to a plurality of mobile chassis; transporting the plurality of power generation assemblies connected to the plurality of mobile chassis to the geographic location; arranging the plurality of power generation assemblies into a modular and scalable power generation operation; and electrically connecting the plurality of the power generation assemblies to the one or more of the one or more power-dependent operations or the one or more power storage devices.

According to a fiftieth aspect of the disclosure, in combination with one or more of the first through the forty-ninth aspect, a power generation assembly to one or more of enhance power efficiency or reduce greenhouse gas emissions associated with a wellsite operation, may include a gas turbine engine positioned to convert fuel into mechanical power, the gas turbine engine comprising an exhaust gas duct positioned to receive exhaust gas during operation of the gas turbine engine; a heat exchanger positioned to receive the exhaust gas during operation of the gas turbine engine, the heat exchanger comprising an exhaust gas inlet positioned to receive exhaust gas from the exhaust gas duct and a liquid inlet positioned to receive liquid from a liquid source, the heat exchanger being positioned to convert liquid into steam via heat from the exhaust gas; a steam turbine positioned to receive steam from the heat exchanger and to convert energy from the steam into mechanical power; and an electric power generation device connected to the steam turbine and positioned to convert the mechanical power from the steam turbine into electrical power.

According to a fifty-first aspect of the disclosure, in combination with one or more of the first through the fiftieth aspect, a power generation assembly to one or more of enhance power efficiency or reduce greenhouse gas emissions associated with a wellsite operation may include a gas turbine engine positioned to convert fuel into mechanical power, the gas turbine engine comprising an exhaust gas duct positioned to receive exhaust gas during operation of the gas turbine engine; a distillation column positioned to receive the exhaust gas during operation of the gas turbine engine, the distillation column comprising: an exhaust gas inlet positioned to receive exhaust gas from the exhaust gas duct; a liquid inlet positioned to receive liquid from a liquid source, the distillation column being positioned to convert liquid into steam via heat from the exhaust gas; and a steam outlet positioned at an upper portion of the distillation column to release steam; and a condenser positioned to receive fluid flow from the steam outlet and to condense steam to provide a distilled liquid for use in wellsite operations.

According to a fifty-second aspect of the disclosure, in combination with one or more of the first through the fifty-first aspect, a method to one or more of enhance power efficiency or reduce greenhouse gas emissions associated with a wellsite operation, may include operating a gas turbine engine to convert fuel into mechanical power; supplying exhaust gas from operation of the gas turbine engine and liquid to a heat exchanger to convert liquid into steam via heat from the exhaust gas; supplying steam to a steam turbine positioned to convert energy from the steam into mechanical power; and supplying the mechanical power from steam turbine to an electric power generation device to convert the mechanical power from the steam turbine into electrical power.

According to a fifty-third aspect of the disclosure, in combination with one or more of the first through the fifty-second aspect, a method to generate power and supply distilled liquid to enhance a wellsite operation, may include operating a gas turbine engine to convert fuel into mechanical power; supplying exhaust gas from operation of the gas turbine engine to a distillation column; supplying liquid to the distillation column; heating the liquid in the distillation column via heat from the exhaust gas to generate steam; supplying the steam to a condenser; condensing the steam via the condenser to provide distilled liquid; and supplying the distilled liquid to the wellsite operation.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

1. A system, comprising:
a first turbine configured to generate a first mechanical power from a first source;
a first generator coupled to the first turbine and coupled to a first load, wherein the first generator is configured to generate a first electrical power from the first mechanical power and to transmit the first electrical power to the first load;
a first conversion device coupled to the first turbine, wherein the first conversion device is configured to receive from the first turbine a first byproduct, to receive a second source, and to use the first byproduct to convert the second source to a third source;
a second turbine coupled to the first conversion device and configured to generate a second mechanical power from the third source; and
a second generator coupled to the second turbine and coupled to a second load, wherein the second generator is configured to generate a second electrical power from the second mechanical power and to transmit the second electrical power to the second load.

2. The system of claim 1, wherein at least one of the first load or the second load comprises at least one of an electric power grid, a solar farm, a wind farm, a wellsite operation, a mining site operation, a wastewater treatment operation, a natural gas production operation, a cryptocurrency operation, a power storage device, a chemical power storage device, a mechanical power storage device, a methane pyrolysis unit, or an electrolysis unit.

3. The system of claim 1, wherein the second source comprises at least one of a flowback water, a produced water, a geothermal water, or a wastewater.

4. The system of claim 1, wherein the second turbine is part of a closed-loop organic Rankine cycle.

5. The system of claim 1, wherein at least one of the first load or the second load comprises a first motor coupled to a first mechanical device, and wherein the first motor is configured to mechanically drive the first mechanical device.

6. The system of claim 5, wherein at least one of the first load or the second load further comprises:
a first variable-frequency drive coupled to the first motor, wherein the first variable-frequency drive is configured to control a voltage to the first motor; and
a first transformer coupled to the first variable-frequency drive.

7. The system of claim 1, further comprising a methanol generation assembly coupled to at least one of the first turbine or the first conversion device and coupled to at least one of the first generator or the second generator, wherein the methanol generation assembly is configured to receive at least one of the first electrical power or the second electrical power, to receive the first byproduct, to receive the second source, and to use the first byproduct and the second source to generate methane.

8. The system of claim 7, wherein the methanol generation assembly comprises:
an electrolysis reactor coupled to at least one of the first generator or the second generator, wherein the electrolysis reactor is configured to receive the second source, to receive at least one of the first electrical power or the second electrical power, and to generate oxygen and hydrogen from the second source; and
a methanol generation reactor coupled to the electrolysis reactor, coupled to at least one of the first turbine or the first conversion device, and coupled to at least one of the first generator or the second generator, wherein the methanol generation reactor is configured to receive at least one of the first electrical power or the second electrical power, to receive the first byproduct, to receive hydrogen from the electrolysis reactor, and to use the first byproduct and the hydrogen to generate methane.

9. The system of claim 1, further comprising a condenser coupled to the first conversion device and coupled to a third load, wherein the condenser is configured to convert the third source to a fourth source and to transmit the fourth source to the third load.

10. The system of claim 1, further comprising one or more mobile chassis, wherein at least one of the first turbine, the first generator, the first conversion device, the second turbine, or the second generator is coupled to the one or more mobile chassis.

11. The system of claim 1, wherein at least one of the first turbine or the first conversion device is coupled to an injection well to transmit the first byproduct to the injection well, and wherein the injection well is configured to receive the first byproduct and to dispose of the first byproduct.

12. A system, comprising:
a first assembly, comprising:
a first mobile chassis;
a first turbine configured to generate a first mechanical power from a first source; and
a first generator coupled to the first turbine and coupled to a first load, wherein the first generator is configured to generate a first electrical power from the first mechanical power and to transmit the first electrical power to the first load,
wherein at least one of the first turbine or the first generator are coupled to the first mobile chassis; and
a second assembly, comprising:
a second mobile chassis;
a first conversion device coupled to the first turbine, wherein the first conversion device is configured to receive from the first turbine a first byproduct, to receive a second source, and to use the first byproduct to convert the second source to a third source;
a second turbine coupled to the first conversion device and configured to generate a second mechanical power from the third source; and
a second generator coupled to the second turbine and coupled to a second load, wherein the second generator is configured to generate a second electrical power from the second mechanical power and to transmit the second electrical power to the second load,
wherein at least one of the first conversion device, the second turbine, or the second generator are coupled to the second mobile chassis.

13. The system of claim 12, wherein at least one of the first load or the second load comprises a first motor coupled to a first mechanical device, and wherein the first motor is configured to mechanically drive the first mechanical device.

14. The system of claim 13, wherein at least one of the first load or the second load further comprises:
a first variable-frequency drive coupled to the first motor, wherein the first variable-frequency drive is configured to control a voltage to the first motor; and
a first transformer coupled to the first variable-frequency drive.

15. The system of claim 12, further comprising a methanol generation assembly coupled to at least one of the first turbine or the first conversion device and coupled to at least one of the first generator or the second generator, wherein the methanol generation assembly is configured to receive at least one of the first electrical power or the second electrical power, to receive the first byproduct, to receive the second source, and to use the first byproduct and the second source to generate methane.

16. The system of claim 15, wherein the methanol generation assembly comprises:
an electrolysis reactor coupled to at least one of the first generator or the second generator, wherein the electrolysis reactor is configured to receive the second source, to receive at least one of the first electrical power or the second electrical power, and to generate oxygen and hydrogen from the second source; and
a methanol generation reactor coupled to the electrolysis reactor, coupled to at least one of the first turbine or the first conversion device, and coupled to at least one of the first generator or the second generator, wherein the methanol generation reactor is configured to receive at least one of the first electrical power or the second electrical power, to receive the first byproduct, to receive hydrogen from the electrolysis reactor, and to use the first byproduct and the hydrogen to generate methane.

17. The system of claim 12, further comprising a condenser coupled to the first conversion device and coupled to a third load, wherein the condenser is configured to convert the third source to a fourth source and to transmit the fourth source to the third load.

18. A method, comprising:
supplying a first source to a first turbine;
operating the first turbine to generate a first mechanical power from the first source;
operating a first generator coupled to the first turbine and coupled to a first load to generate a first electrical power from the first mechanical power and to transmit the first electrical power to the first load;
supplying a first byproduct from the operation of the first turbine to a first conversion device coupled to the first turbine and coupled to a second turbine;
operating the first conversion device to use the first byproduct to convert a second source to a third source and to supply the third source to the second turbine;
operating the second turbine to generate a second mechanical power from the third source; and
operating a second generator coupled to the second turbine and coupled to a second load to generate a second electrical power from the second mechanical power and to transmit the second electrical power to the second load.

19. The method of claim 18, further comprising:
connecting to one or more of a mobile chassis at least one of the first turbine, the first generator, the first conversion device, the second turbine, or the second generator.

20. The method of claim 19, further comprising:
transporting at least one of the one or more mobile chassis to a location associated with at least one of the first load or the second load.
